(19) United States
(12) Patent Application Publication
(10) Pub. No.: US 2026/0295884 A1
(43) Pub. Date: Oct. 1, 2026

(54) APPARATUS AND METHOD FOR PEELING AN OUTER SURFACE OF A TUBULAR ELEMENT

(71) Applicants: Friedrich OSWALD, Grimsby (CA); Sascha OSWALD, Grimsby (CA)

(72) Inventors: Friedrich OSWALD, Grimsby (CA); Sascha OSWALD, Grimsby (CA)

(21) Appl. No.: 19/551,159

(22) Filed: Feb. 26, 2026

Related U.S. Application Data
(60) Provisional application No. 63/777,388, filed on Mar. 25, 2025.

(51) Int. Cl. B26D 3/28

(52) U.S. Cl. CPC B26D 3/282; B26D 3/283; B26D 2003/286; B26D 2003/287

(57) ABSTRACT

Disclosed is an apparatus for peeling a tubular element, comprising a peeler assembly that comprises a housing and a blade, a guiding sleeve for aligning the apparatus and the tubular element, and a mandrel assembly for engaging with the tubular element. In response to rotation of the peeler assembly, relative to the mandrel assembly, in a first rotation direction: the sleeve is rotated, relative to the mandrel assembly, in the first rotation direction; and the peeler assembly is longitudinally displaced, relative to the mandrel assembly and relative to the sleeve, in a first longitudinal direction. In response to rotation of the peeler assembly, relative to the mandrel assembly, in a second rotation direction: the sleeve is rotated, relative to the mandrel assembly, in the second rotation direction, and the peeler assembly is longitudinally displaced, relative to the mandrel assembly and relative to the sleeve, in a second longitudinal direction.

### CROSS-REFERENCE TO RELATED APPLICATIONS

This application claims benefit of U.S. Provisional Patent Application Ser. No. 63/777,388, filed Mar. 25, 2025, which is incorporated herein by reference in its entirety.

### FIELD

The invention relates to the field of peeling an outer surface of a tubular element, and in particular, to align a peeler with the tubular element for peeling the tubular element.

### BACKGROUND

In the field of pipe fitting, it is commonplace to peel the outer surface of a tubular element, for example, an end of a pipe or pipe fitting, such as a coupling, a saddle, a tap tee, and the like, in preparation for coupling the peeled tubular element with another component. It is also commonplace to peel the end of a tubular element to prepare the tubular element for electrofusion (removal of oxidation layer).

It is desirable to align the peeler apparatus with the tubular element to be peeled, for improved engagement between the peeler apparatus and the tubular element, which can improve the quality of the peeling of the tubular element.

### SUMMARY

In one aspect, there is provided an apparatus for peeling an outer surface of a tubular element of a tubular element assembly, the apparatus comprising: a peeler assembly, comprising: a housing, comprising an end wall; and a blade assembly, comprising a blade, the blade assembly operably coupled to the housing, and configurable in an element-receiving configuration and an element-peeling configuration; a guiding sleeve, disposed in the housing, the guiding sleeve comprising: a sleeve end wall; and a sleeve wall that extends from the sleeve end wall, the sleeve wall defining a sleeve cavity configured to receive the tubular element assembly, the sleeve wall including an inward-facing guide surface that is configured to co-operate with the outer surface of the tubular element to align the apparatus and the tubular element assembly, in response to receiving of the tubular element assembly in the sleeve cavity of the guiding sleeve; wherein the guiding sleeve is configurable in a retracted configuration and an extended configuration; a mandrel assembly, extending through the sleeve end wall, the mandrel assembly comprising: a mandrel, configured to engage with the tubular element assembly; and a shaft, received in the end wall of the housing; wherein: in the element-receiving configuration of the blade assembly, there is an absence of disposition of the blade in the sleeve cavity, and, in the element-peeling configuration of the blade assembly, the blade is disposed closer to a central longitudinal axis of the guiding sleeve, relative to its disposition while in the element-receiving configuration; in the extended configuration of the guiding sleeve, the guiding sleeve is spaced further apart from the end wall of the housing, relative to its disposition while in the retracted configuration; the peeler assembly, the guiding sleeve, and the mandrel assembly are co-operatively configured such that: in response to rotation of the peeler assembly, relative to the mandrel assembly, in a first rotation direction, about a rotation axis that is parallel to a central longitudinal axis of the housing: the guiding sleeve is rotated, relative to the mandrel assembly, in the first rotation direction, about the rotation axis; and the peeler assembly is longitudinally displaced, relative to the mandrel assembly and relative to the guiding sleeve, in a first longitudinal direction, along a displacement axis that is parallel to the central longitudinal axis of the housing, such that a minimum spacing distance between the guiding sleeve and the end wall of the housing is decreased; and in response to rotation of the peeler assembly, relative to the mandrel assembly, in a second rotation direction that is opposite the first rotation direction, about the rotation axis: the guiding sleeve is rotated, relative to the mandrel assembly, in the second rotation direction, about the rotation axis; and the peeler assembly is longitudinally displaced, relative to the mandrel assembly and relative to the guiding sleeve, in a second longitudinal direction that is opposite the first longitudinal direction, along the displacement axis, such that the minimum spacing distance between the guiding sleeve and the end wall of the housing is increased; while: (i) the guiding sleeve is disposed in the extended configuration, and (ii) the blade assembly is disposed in the element-receiving configuration: the tubular element assembly is receivable in the sleeve cavity of the guiding sleeve for disposing the tubular element assembly in engagement with the mandrel, the receiving of the tubular element assembly in the sleeve cavity of the guiding sleeve is with effect that the apparatus and the tubular element assembly become disposed in alignment via co-operation of the inward-facing guide surface of the sleeve wall and the outer surface of the tubular element; while: (i) the guiding sleeve is disposed in the extended configuration, (ii) the tubular element assembly is received in the sleeve cavity of the guiding sleeve, such that the apparatus and the tubular element assembly are disposed in alignment, (iii) the tubular element assembly is disposed in engagement with the mandrel, and (iv) the blade assembly is disposed in the element-receiving configuration: the blade assembly is transitioned from the element-receiving configuration to the element-peeling configuration, with effect that the blade becomes disposed in engagement with the outer surface of the tubular element; while: (i) the guiding sleeve is disposed in the extended configuration, (ii) the tubular element assembly is received in the sleeve cavity of the guiding sleeve, such that the apparatus and the tubular element assembly are disposed in alignment, (iii) the tubular element assembly is disposed in engagement with the mandrel, and (iv) the blade assembly is disposed in the element-peeling configuration, such that the blade is disposed in engagement with the outer surface of the tubular element: in response to rotation of the peeler assembly, relative to the mandrel assembly and relative to the tubular element assembly, in the first rotation direction, about the rotation axis: the guiding sleeve is rotated, relative to the mandrel assembly and relative to the tubular element assembly, in the first rotation direction, about the rotation axis, and the peeler assembly is longitudinally displaced, relative to the mandrel assembly, the guiding sleeve, and the tubular element assembly, in the first longitudinal direction, along the displacement axis, with effect that the outer surface of the tubular element is peeled by the blade, such that a peeled tubular element assembly is defined, and with further effect that the guiding sleeve becomes disposed in the retracted configuration.

In another aspect, there is provided an apparatus for peeling an outer surface of a tubular element of a tubular element assembly, the apparatus comprising: a peeler assembly, comprising: a housing, comprising an end wall; and a blade assembly, comprising a blade, the blade assembly operably coupled to the housing; a guiding sleeve, disposed in the housing, the guiding sleeve comprising: a sleeve end wall; and a sleeve wall that extends from the sleeve end wall, the sleeve wall defining a sleeve cavity configured to receive the tubular element assembly, the sleeve wall including an inward-facing guide surface that is configured to co-operate with the outer surface of the tubular element to align the apparatus and the tubular element assembly, in response to receiving of the tubular element assembly in the sleeve cavity of the guiding sleeve; a mandrel assembly, operably coupled to the guiding sleeve and to the housing, the mandrel assembly comprising: a mandrel, configured to engage with the tubular element assembly; wherein: the peeler assembly, the guiding sleeve, and the mandrel assembly are co-operatively configured such that: in response to rotation of the peeler assembly, relative to the mandrel assembly, in a first rotation direction, about a rotation axis that is parallel to a central longitudinal axis of the housing: the guiding sleeve is rotated, relative to the mandrel assembly, in the first rotation direction, about the rotation axis; and the peeler assembly is longitudinally displaced, relative to the mandrel assembly and relative to the guiding sleeve, in a first longitudinal direction, along a displacement axis that is parallel to the central longitudinal axis of the housing, such that a minimum spacing distance between the guiding sleeve and the end wall of the housing is decreased; and in response to rotation of the peeler assembly, relative to the mandrel assembly, in a second rotation direction that is opposite the first rotation direction, about the rotation axis: the guiding sleeve is rotated, relative to the mandrel assembly, in the second rotation direction, about the rotation axis; and the peeler assembly is longitudinally displaced, relative to the mandrel assembly and relative to the guiding sleeve, in a second longitudinal direction that is opposite the first longitudinal direction, along the displacement axis, such that the minimum spacing distance between the guiding sleeve and the end wall of the housing is increased; while: (i) the tubular element assembly is received in the sleeve cavity of the guiding sleeve, such that the apparatus and the tubular element assembly are disposed in alignment via co-operation of the inward-facing guide surface of the sleeve wall and the outer surface of the tubular element, (ii) the tubular element assembly is disposed in engagement with the mandrel, and (iii) the blade is disposed in engagement with the outer surface of the tubular element: in response to rotation of the peeler assembly, relative to the mandrel assembly and relative to the tubular element assembly, in the first rotation direction, about the rotation axis: the guiding sleeve is rotated, relative to the mandrel assembly and relative to the tubular element assembly, in the first rotation direction, about the rotation axis, and the peeler assembly is longitudinally displaced, relative to the mandrel assembly, the guiding sleeve, and the tubular element assembly, in the first longitudinal direction, along the displacement axis, with effect that the outer surface of the tubular element is peeled by the blade, such that a peeled tubular element assembly is defined.

In another aspect, there is provided a method of peeling an outer surface of a tubular element of a tubular element assembly with an apparatus, the apparatus comprising: a peeler assembly, comprising: a housing, comprising an end wall; and a blade assembly, comprising a blade, the blade assembly operably coupled to the housing; a guiding sleeve, disposed in the housing, the guiding sleeve comprising: a sleeve end wall; and a sleeve wall that extends from the sleeve end wall, the sleeve wall defining a sleeve cavity configured to receive the tubular element assembly, the sleeve wall including an inward-facing guide surface that is configured to co-operate with the outer surface of the tubular element to align the apparatus and the tubular element assembly, in response to receiving of the tubular element assembly in the sleeve cavity of the guiding sleeve; a mandrel assembly, operably coupled to the guiding sleeve and to the housing, the mandrel assembly comprising: a mandrel, configured to engage with the tubular element assembly; wherein: the peeler assembly, the guiding sleeve, and the mandrel assembly are co-operatively configured such that: in response to rotation of the peeler assembly, relative to the mandrel assembly, in a first rotation direction, about a rotation axis that is parallel to a central longitudinal axis of the housing: the guiding sleeve is rotated, relative to the mandrel assembly, in the first rotation direction, about the rotation axis; and the peeler assembly is longitudinally displaced, relative to the mandrel assembly and relative to the guiding sleeve, in a first longitudinal direction, along a displacement axis that is parallel to the central longitudinal axis of the housing, such that a minimum spacing distance between the guiding sleeve and the end wall of the housing is decreased; and in response to rotation of the peeler assembly, relative to the mandrel assembly, in a second rotation direction that is opposite the first rotation direction, about the rotation axis: the guiding sleeve is rotated, relative to the mandrel assembly, in the second rotation direction, about the rotation axis; and the peeler assembly is longitudinally displaced, relative to the mandrel assembly and relative to the guiding sleeve, in a second longitudinal direction that is opposite the first longitudinal direction, along the displacement axis, such that the minimum spacing distance between the guiding sleeve and the end wall of the housing is increased; the method comprising: while: (i) the tubular element assembly is received in the sleeve cavity of the guiding sleeve, such that the apparatus and the tubular element assembly are disposed in alignment via co-operation of the inward-facing guide surface of the sleeve wall and the outer surface of the tubular element, (ii) the tubular element assembly is disposed in engagement with the mandrel, and (iii) the blade is disposed in engagement with the outer surface of the tubular element: rotating the peeler assembly, relative to the mandrel assembly and relative to the tubular element assembly, in the first rotation direction, about the rotation axis, with effect that the guiding sleeve is rotated, relative to the mandrel assembly and relative to the tubular element assembly, in the first rotation direction, and the peeler assembly is longitudinally displaced, relative to the mandrel assembly, the guiding sleeve, and the tubular element assembly, in the first longitudinal direction, along the displacement axis, with effect that the outer surface of the tubular element is peeled by the blade, such that a peeled tubular element assembly is defined.

Other aspects will be apparent from the description and drawings provided herein.

### BRIEF DESCRIPTION OF DRAWINGS

In the figures, which illustrate example embodiments,

FIG. 1 is a front perspective view of an example embodiment of an apparatus for peeling an outer surface of a tubular element of a tubular element assembly.

FIG. 2 is a rear perspective view of the apparatus of FIG. 1.

FIG. 3 is a left side view of the apparatus of FIG. 1.

FIG. 4 is a top view of the apparatus of FIG. 1.

FIG. 5 is a front view of the apparatus of FIG. 1.

FIG. 6 is a rear view of the apparatus of FIG. 1.

FIG. 7 is a cross-sectional view of the apparatus of FIG. 1, taken along line B-B of FIG. 3.

FIG. 8 is a cross-sectional view of the apparatus of FIG. 1, taken along line C-C of FIG. 3.

FIG. 9 is an exploded view of the apparatus of FIG. 1.

FIG. 10 is a perspective view of a blade assembly of the apparatus of FIG. 1, and a fastener about which the blade assembly rotates.

FIG. 11 is a perspective view of a mandrel assembly and a guiding sleeve of the apparatus of FIG. 1.

FIG. 12 is a cross-sectional view of the apparatus of FIG. 1, wherein the blade assembly is disposed in an element-receiving configuration, and the guiding sleeve is disposed in an extended configuration.

FIG. 13 is a cross-sectional view of the apparatus of FIG. 1, wherein the blade assembly is disposed in the element-peeling configuration, and the guiding sleeve is disposed in an extended configuration.

FIG. 14 is a cross-sectional view of the apparatus of FIG. 1, wherein the blade assembly is disposed in the element-peeling configuration, and the guiding sleeve is disposed in a retracted configuration.

FIG. 15 is a perspective view of the apparatus of FIG. 1, wherein the guiding sleeve is disposed in an extended configuration, the blade assembly is disposed in the element-peeling configuration, and a tubular element assembly is received in the guiding sleeve and is engaged with a mandrel of the apparatus of FIG. 1.

FIG. 16 is a cross-sectional view of the apparatus and the tubular element assembly of FIG. 15.

FIG. 17 is a perspective view of the apparatus of FIG. 1, wherein the guiding sleeve is disposed in a retracted configuration, the tubular element assembly is received in the guiding sleeve and is engaged with the mandrel, the blade assembly is disposed in the element-peeling configuration, and the outer surface of the tubular element of the tubular element assembly has been peeled, such that a peeled tubular element assembly is defined.

FIG. 18 is a cross-sectional view of the apparatus and the tubular element assembly of FIG. 17.

FIG. 19 is a perspective view of a peeled tubular element assembly.

FIG. 20 is a cross-sectional view of the apparatus of FIG. 1, wherein the guiding sleeve is disposed in an extended configuration, the tubular element assembly is received in the guiding sleeve, the blade assembly is disposed in the element-peeling configuration, and a flow control valve of the tubular element assembly is engaged with the mandrel of the apparatus of FIG. 1.

FIG. 21 is a perspective view of the apparatus of FIG. 1, wherein the guiding sleeve is disposed in a retracted configuration, the tubular element assembly is received in the guiding sleeve, the blade assembly is disposed in the element-peeling configuration, the flow control valve of the tubular element assembly is engaged with the mandrel, and the outer surface of the tubular element of the tubular element assembly has been peeled, such that a peeled tubular element assembly is defined.

### DETAILED DESCRIPTION

With reference to the Figures, an apparatus 20 for peeling an outer surface 14 of a tubular element 12 of a tubular element assembly 10 will be described according to example embodiments, along with a method of peeling the outer surface 14 of the tubular element 12 of a tubular element assembly 10 with the apparatus 20.

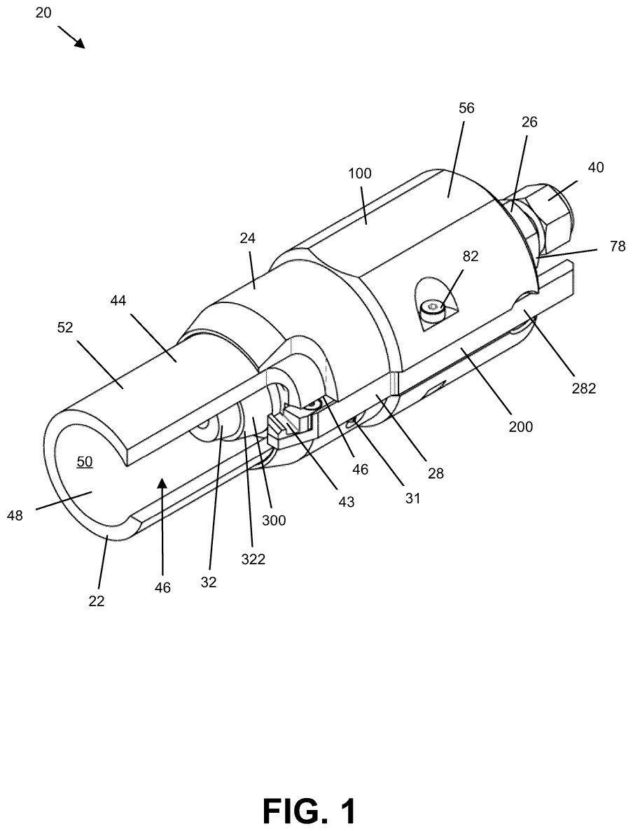

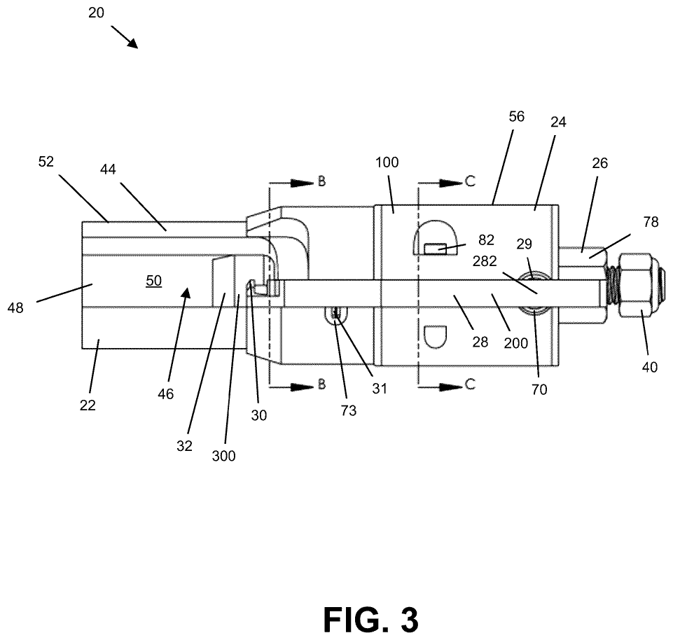

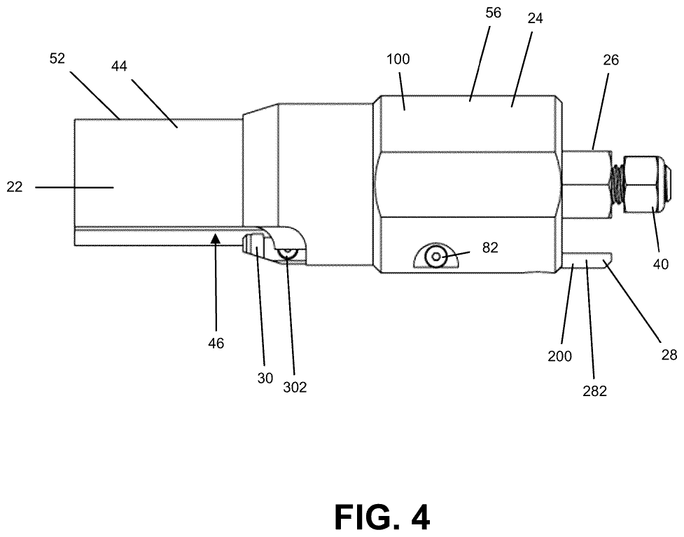

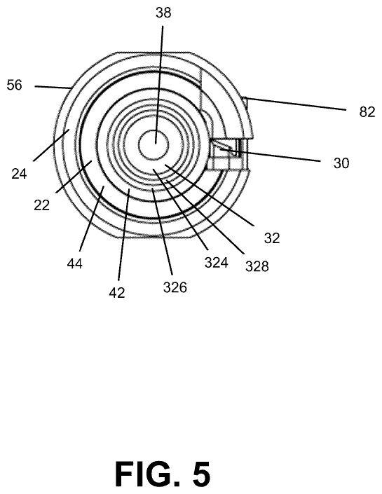

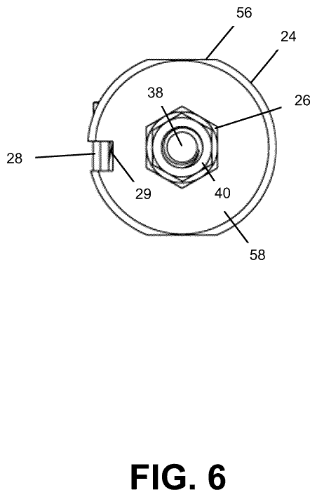

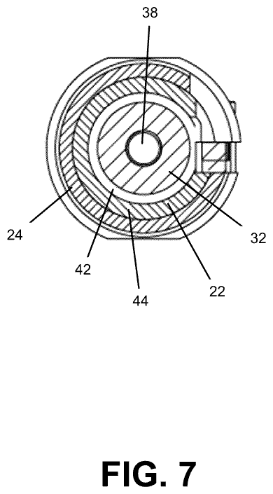

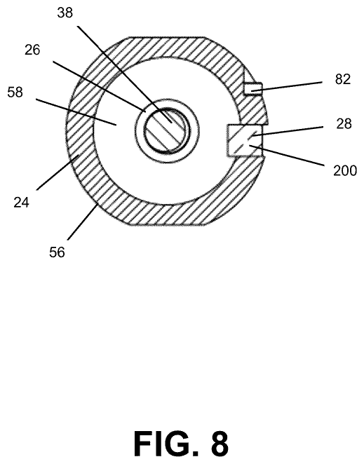

In some embodiments, for example, as depicted in FIG. 1 to FIG. 9, the apparatus 20 comprises a peeler assembly 100. The peeler assembly 100 comprises a housing 24, comprising an outer surface 56 and an end wall 58. The peeler assembly 100 further comprises a blade assembly 200. In some embodiments, for example, the blade assembly 200 comprises a peeling blade 30 and an arm 28. In some embodiments, for example, the blade 30 is secured to the arm 28 by a fastener 302, such as a bolt. The blade assembly 200, for example, the blade 30, is configured to peel the outer surface 14 of the tubular element 12 of the tubular element assembly 10, as described in greater detail herein.

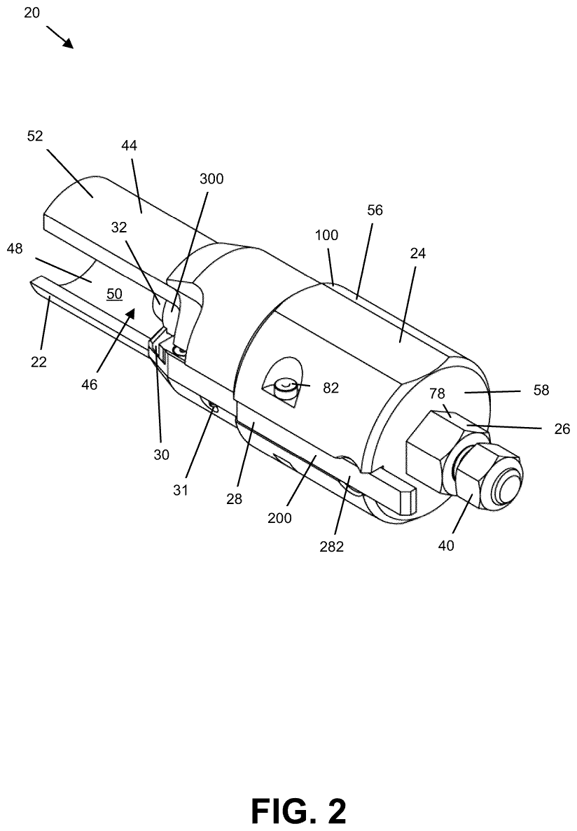

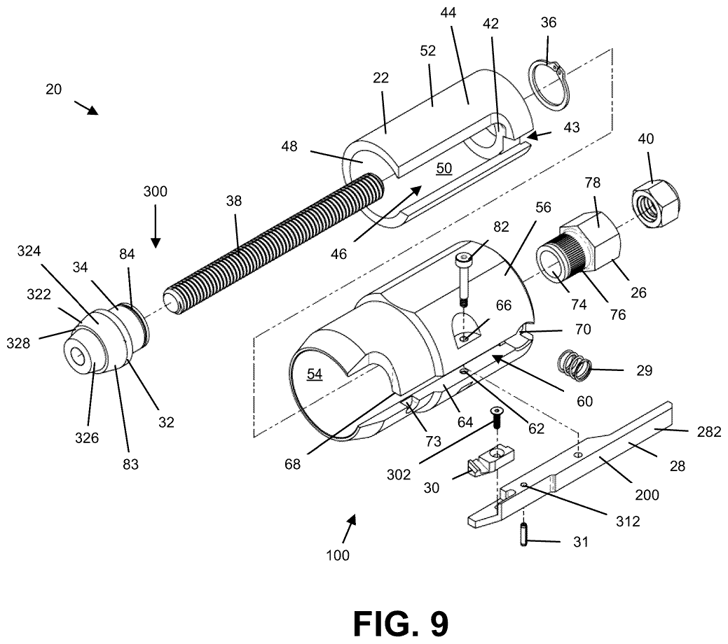

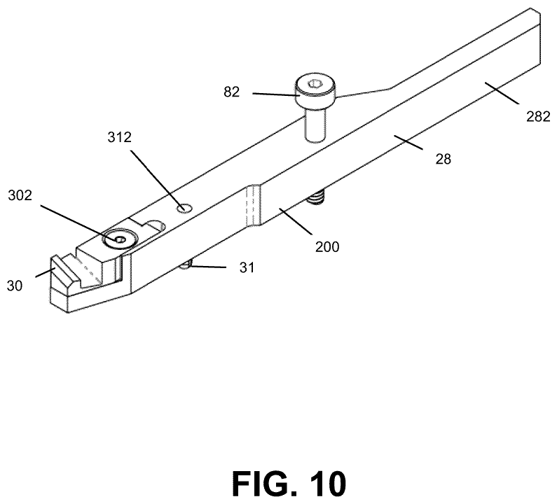

In some embodiments, for example, the blade assembly 200 is operably coupled to the housing 24. In some embodiments, for example, the housing 24 defines a slot 60 in which the blade assembly 200 is disposed. As depicted in FIG. 1, FIG. 2, and FIG. 9, the slot 60 extends longitudinally along an axis that is parallel to the central longitudinal axis 24A of the housing 24. In some embodiments, for example, the housing 24 defines a fastener receiver 62, for example, a threaded hole or a threaded bore 62, on a surface 64 of the slot 60, and further defines a fastener receiver 66, for example, a through hole or throughbore 66, that is disposed in opposing relationship relative to the fastener receiver 62, the fastener receiver 66 defined on a surface 68 of the slot 60 that is opposite the surface 64. In some embodiments, for example, as depicted in FIG. 9 and FIG. 10, the blade assembly 200, for example, the arm 28, is operably coupled to the housing 24 by a fastener 82, for example, a bolt 82 or a spring pin, that extends through throughbore 66 into threaded bore 62.

In some embodiments, for example, the apparatus 20 comprises a guiding sleeve 22. In some embodiments, for example, as depicted in FIG. 1 to FIG. 4, the guiding sleeve 22 is disposed in the housing 24. In some embodiments, for example, the housing 24 defines a housing cavity 54, in which the guiding sleeve 22 is received for effectuating the disposition of the guiding sleeve 22 in the housing 24. In some embodiments, for example, the disposition of the guiding sleeve 22 in the housing 24 is such that there is a clearance fit between the guiding sleeve 22 and the housing 24, to oppose binding of the guiding sleeve 22 and the housing 24.

In some embodiments, for example, as depicted in FIG. 9, the guiding sleeve 22 comprises a sleeve end wall 42, which, in some embodiments, for example, is a rounded or circular wall. In some embodiments, for example, the guiding sleeve 22 comprises a sleeve wall 44 that extends from the sleeve end wall 42. In some embodiments, for example, the sleeve wall 44 defines a sleeve cavity 50 configured to receive the tubular element assembly 10. In some embodiments, for example, the sleeve cavity 50 has a length, measured along an axis that is parallel to a central longitudinal axis 22A of the guiding sleeve 22, having a minimum value of at least 46 millimeters.

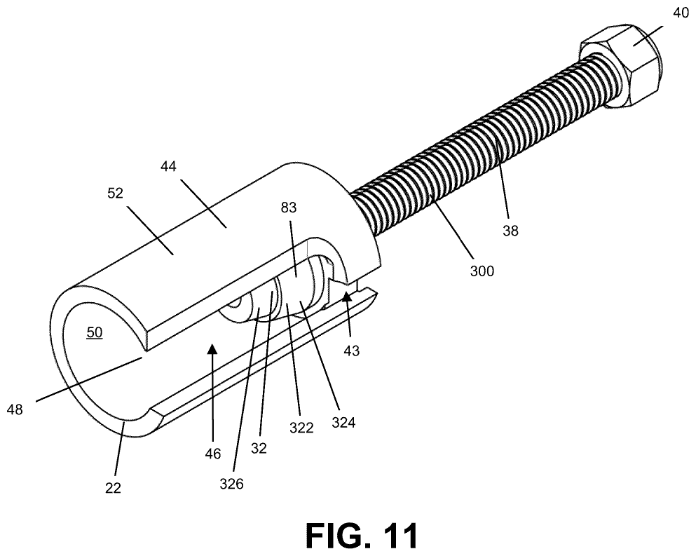

In some embodiments, for example, as depicted in FIG. 1, FIG. 2, FIG. 9, and in FIG. 11 to FIG. 14, the sleeve wall 44 includes an inward-facing guide surface 48 that is configured to co-operate with the outer surface 14 of the tubular element 12 to align the apparatus 20 and the tubular element assembly 10, in response to receiving of the tubular element assembly 10 in the sleeve cavity 50 of the guiding sleeve 22. In some embodiments, for example, the inward-facing guide surface 48 is an arcuate surface. In some embodiments, for example, the inward-facing guide surface 48 has a radius having a minimum value of at least eight (8) millimeters, for example, at least 10 millimeters, for example, at least 20 millimeters, for example, at least 30 millimeters. In some embodiments, for example, the inward-facing guide surface 48 has a radius that is at least 0.125 millimeters, for example, at least 0.15 millimeters, for example, at least 0.165 millimeters, greater than the radius of the outer surface 14 of the tubular element 12. In some embodiments, for example, the fit of the guiding sleeve 22 over the tubular element 12 is such that it is sufficiently tight to effectuate alignment of the apparatus 20 and the tubular element assembly 10, while also allowing the guiding sleeve 22 to rotate, relative to the tubular element assembly 10, without binding, as described in greater detail herein. In some embodiments, for example, the fit between the guiding sleeve 22 and the tubular element 12 is a transitional fit, wherein, in some embodiments, for example, there is clearance between the guiding sleeve 22 and the tubular element 12, and, in other embodiments, for example, there is interference between the guiding sleeve 22 and the tubular element 12 such that there is deformation of one or both of the guiding sleeve 22 and the tubular element 12.

In some embodiments, for example, the sleeve wall 44 includes an outward-facing surface 52. In some embodiments, for example, the outward-facing surface 52 is an arcuate surface.

In some embodiments, for example, the apparatus 20 comprises a mandrel assembly 300 that is operably coupled to the guiding sleeve 22 and to the housing 24. In some embodiments, for example, as depicted in FIG. 11 to FIG. 14, the mandrel assembly 300 extends through the sleeve end wall 42. In some embodiments, for example, the mandrel assembly 300 comprises a mandrel 32, which is configured to engage with the tubular element assembly 10. In some embodiments, for example, the mandrel 32 is disposed in the sleeve cavity 50. In some embodiments, for example, as depicted in FIG. 1, and FIG. 11 to FIG. 14, the mandrel assembly 300 further comprises a shaft 38, received in the end wall 58 of the housing 24. In some embodiments, for example, the end wall 58 of the housing 24 defines a shaft receiver 72, for example, a hole or a bore 72, for receiving the shaft 38. In some embodiments, for example, the receiving of the shaft 38 in the end wall 58 is such that the shaft 38 extends through the end wall 58, for example, via the shaft receiver 72.

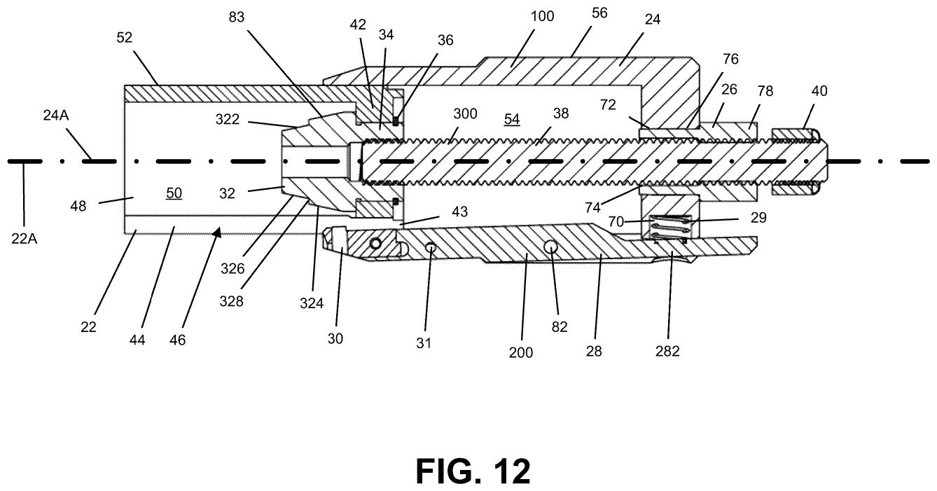

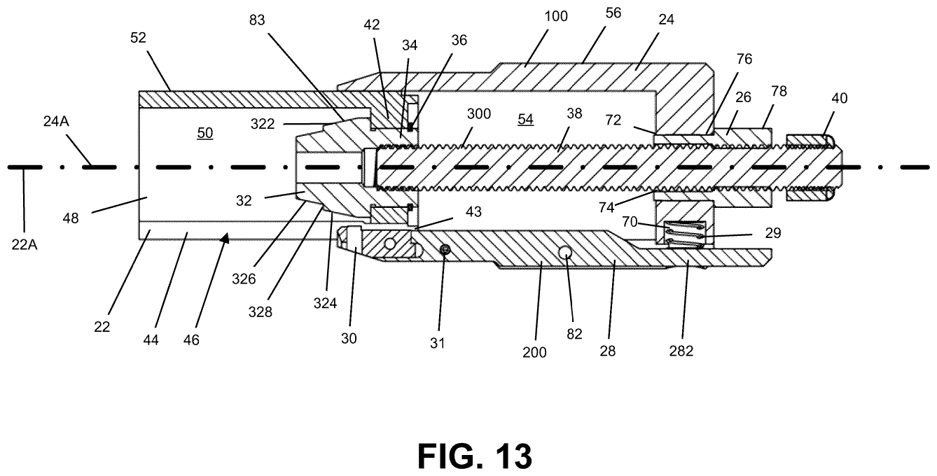

In some embodiments, for example, the blade assembly 200 is configurable in an element-receiving configuration, as depicted in FIG. 12, and an element-peeling configuration, as depicted in FIG. 13. In the element-receiving configuration of the blade assembly 200, there is an absence of disposition of the blade assembly 200, for example, the blade 30, in the sleeve cavity 50, and, in the element-peeling configuration of the blade assembly 200, the blade assembly 200, for example, the blade 30, is disposed closer to the central longitudinal axis 22A of the guiding sleeve 22, relative to its disposition while in the element-receiving configuration. In some embodiments, for example, in the element-peeling configuration of the blade assembly 200, the blade 30 is disposed in the sleeve cavity 50.

In some embodiments, for example, the blade assembly 200 is transitionable between the element-receiving configuration and the element-peeling configuration via rotation of the blade assembly 200, relative to the housing 24, about the fastener 82.

In some embodiments, for example, the blade assembly 200 is biased, for example, by a biasing force applied by a biasing element 29 to the blade assembly 200, to the element-peeling configuration. In some embodiments, for example, the housing 24 defines a recess 70, in which the biasing element 29 is defined. As depicted in FIG. 1 to FIG. 3, and FIG. 9, in some embodiments, for example, the recess 70 is defined by the housing 24 at an end of the slot 60 adjacent to the end wall 58. In some embodiments, for example, the biasing element 29 is disposed opposite the arm 28 of the blade assembly 200. In some embodiments, for example, the biasing element 29 is disposed opposite an end 282 of the arm 28 that is opposite to the end of the arm 28 at which the blade 30 is secured, as depicted in FIG. 10. In some embodiments, for example, the biasing element 29 is captured in the recess 70 by the end 282 of the arm 28.

In some embodiments, for example, the biasing of the blade assembly 200 to the element-peeling configuration is such that, while the outer surface 14 of the tubular element 12 is being peeled, the blade 30 follows the contour of the outer surface 14 of the tubular element 12, for example, even if the outer surface 14 of the tubular element 12 has an oval shape or has out-of-round conditions (that are within pipe manufacturer's limits).

In some embodiments, for example, while the end 282 of the arm 28 is disposed in abutting engagement with the biasing element 29, the end 282 of the arm 28 and the biasing element 29 are co-operatively configured such that rotation of the arm 28, relative to the housing 24, about the fastener 82, with effect that the minimum spacing distance between the end 282 of the arm 28 and a central longitudinal axis 24A of the housing 24, or between the end 282 of the arm 28 and the central longitudinal axis 22A of the guiding sleeve 22, is reduced, is opposed, for example, prevented, by the biasing element 29. In some embodiments, for example, while the end 282 of the arm 28 is disposed in abutting engagement with the housing 24, the end 282 of the arm 28 and the housing 24 are co-operatively configured such that rotation of the arm 28, relative to the housing 24, about the fastener 82, with effect that the minimum spacing distance between the end 282 of the arm 28 and the central longitudinal axis 24A of the housing 24, or between the end 282 of the arm 28 and the central longitudinal axis 22A of the guiding sleeve 22, is reduced, is opposed, for example, prevented, by the housing 24. In this respect, in some embodiments, for example, the end 282 of the arm 28 and the biasing element 29 and/or the housing 24 co-operate to define a limit for such rotation of the arm 28, relative to the housing 24, about the fastener 82. In some embodiments, for example, it is desirable to limit such rotation of the arm 28, relative to the housing 24, about the fastener 82, as excessive such rotation of the arm 28, relative to the housing 24, about the fastener 82, can expose the blade 30 to the environment, thereby presenting a safety risk to a user of the apparatus 20.

In some embodiments, for example, a spring pin 31 is received in a pin receiver 312, for example, a bore, defined by the arm 28, as depicted in FIG. 9 and FIG. 10, and the housing 24 defines a recessed surface 73, as depicted in FIG. 9. In some embodiments, for example, the recessed surface 73 is recessed radially inward from the outer surface 56 of the housing 24. In some embodiments, for example, the defining of the recessed surface 73 by the housing 24 is such that a discontinuity is defined in the surface 64, as depicted in FIG. 9. In some embodiments, for example, the spring pin 31 and the recessed surface 73 are disposed on a first side of the fastener 82, and the biasing element 29 and the recess 70 are disposed on a second side of the fastener 82 that is opposite the first side. In some embodiments, for example, while the spring pin 31 is disposed in abutting engagement with the recessed surface 73, the spring pin 31 and the recessed surface 73 are co-operatively configured such that rotation of the arm 28, relative to the housing 24, about the fastener 82, with effect that the minimum spacing distance between the blade 30 and the central longitudinal axis 24A of the housing 24, or between the blade 30 and the central longitudinal axis 22A of the guiding sleeve 22, is reduced, is opposed, for example, prevented. In this respect, in some embodiments, for example, the spring pin 31 and the recessed surface 73 co-operate to define a limit for such rotation of the arm 28, relative to the housing 24, about the fastener 82. In some embodiments, for example, it is desirable to limit such rotation of the arm 28, relative to the housing 24, about the fastener 82, as excessive such rotation of the arm 28, relative to the housing 24, about the fastener 82, can defeat the disposition of the end 282 of the arm 28 and the biasing element 29 in opposing relationship, which can create a risk of the biasing element 29 falling out of the recess 70.

In some embodiments, for example, the guiding sleeve 22 is configurable in a retracted configuration and an extended configuration. In the extended configuration of the guiding sleeve 22, the guiding sleeve 22 is spaced further apart from the end wall 58 of the housing 24, relative to its disposition while in the retracted configuration.

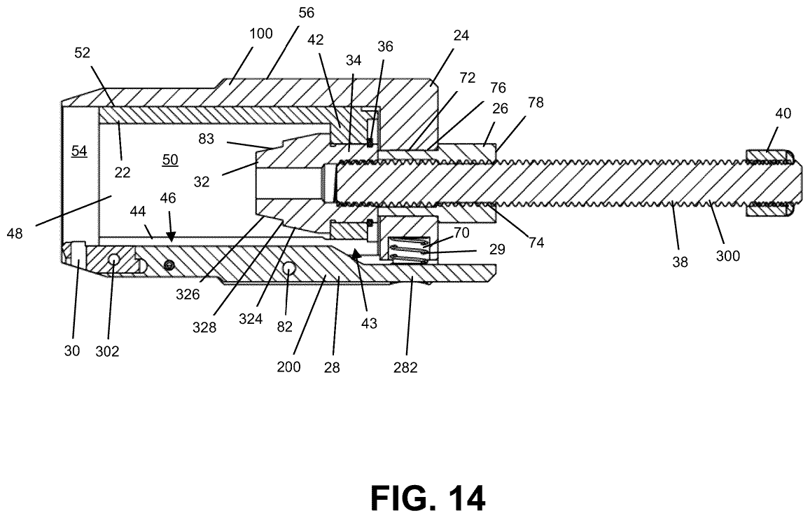

FIG. 14 depicts the apparatus 20 wherein the guiding sleeve 22 is disposed in a retracted configuration. In some embodiments, for example, the guided sleeve 22 is disposed in the retracted configuration while the guided sleeve 22 is disposed in a fully retracted configuration, as depicted in FIG. 14, wherein longitudinal displacement of the peeler assembly 100, relative to the mandrel assembly 300 and relative to the guiding sleeve 22, in a first longitudinal direction, along a displacement axis, for example, in response to rotation of the peeler assembly 100, relative to the mandrel assembly 300, in a first rotation direction, about a rotation axis, as described in greater detail herein, is opposed, for example, prevented. In some embodiments, for example, while the mandrel assembly 300, for example, a boss 34 of the mandrel 32, is disposed in abutting engagement with the end wall 58 of the housing 24 or with a coupler 26 of the peeler assembly 100, the guided sleeve 22 is disposed in the fully retracted configuration.

FIG. 12 and FIG. 13 depict the apparatus 20 wherein the guiding sleeve 22 is disposed in an extended configuration. In some embodiments, for example, the guided sleeve 22 is disposed in an extended configuration while the guided sleeve 22 is disposed in a fully extended configuration, wherein longitudinal displacement of the peeler assembly 100, relative to the mandrel assembly 300 and relative to the guiding sleeve 22, in a second longitudinal direction, along the displacement axis, in response to rotation of the peeler assembly 100, relative to the mandrel assembly 300, in a second rotation direction, about the rotation axis, as described in greater detail herein, is opposed, for example, prevented. In some embodiments, for example, the apparatus 20 comprises a cap nut 40 that is operably coupled to the shaft 38. In some embodiments, for example, the shaft 38 is a threaded shaft 38, and the cap nut 40 is operably coupled to the threads of the threaded shaft 38 by threads of the cap nut 40. In some embodiments, for example, while the cap nut 40 is disposed in abutting engagement with the peeler assembly 100, for example, the coupler 26 of the peeler assembly 100, the guided sleeve 22 is disposed in the fully extended configuration.

In some embodiments, for example, the peeler assembly 100, the guiding sleeve 22, and the mandrel assembly 300 are co-operatively configured such that: in response to rotation of the peeler assembly 100, relative to the mandrel assembly 300, in a first rotation direction, about a rotation axis that is parallel to the central longitudinal axis 24A of the housing 24: the guiding sleeve 22 is rotated, relative to the mandrel assembly 300, in the first rotation direction, about the rotation axis; and the peeler assembly 100 is longitudinally displaced, relative to the mandrel assembly 300 and relative to the guiding sleeve 22, in a first longitudinal direction, along a displacement axis that is parallel to the central longitudinal axis 24A of the housing 24, such that a minimum spacing distance between the guiding sleeve 22 and the end wall 58 of the housing 24 is decreased.

In some embodiments, for example, the peeler assembly 100, the guiding sleeve 22, and the mandrel assembly 300 are further co-operatively configured such that: in response to rotation of the peeler assembly 100, relative to the mandrel assembly 300, in a second rotation direction that is opposite the first rotation direction, about the rotation axis: the guiding sleeve 22 is rotated, relative to the mandrel assembly 300, in the second rotation direction, about the rotation axis; and the peeler assembly 100 is longitudinally displaced, relative to the mandrel assembly 300 and relative to the guiding sleeve 22, in a second longitudinal direction that is opposite the first longitudinal direction, along the displacement axis, such that the minimum spacing distance between the guiding sleeve 22 and the end wall 58 of the housing 24 is increased.

In some embodiments, for example, the guiding sleeve 22 is rotated, relative to the mandrel assembly 300, in the first rotation direction, about the rotation axis, in response to rotation of the peeler assembly 100, relative to the mandrel assembly 300, in the first rotation direction, about the rotation axis, and, the guiding sleeve 22 is rotated, relative to the mandrel assembly 300, in the second rotation direction, about the rotation axis, in response to rotation of the peeler assembly 100, relative to the mandrel assembly 300, in the second rotation direction, about the rotation axis. In some embodiments, for example, the guiding sleeve 22 and the peeler assembly 100 are operably coupled to effectuate the rotation of the guiding sleeve 22, relative to the mandrel assembly 300, in response to rotation of the peeler assembly 100, relative to the mandrel assembly 300.

In some embodiments, for example, the guiding sleeve 22 defines a notch 43, as depicted in FIG. 9 and FIG. 11, and the blade assembly 200, for example, the arm 28, extends through the notch 43, as depicted in FIG. 1, FIG. 12, and FIG. 13. In some embodiments, for example, the extension of the blade assembly 200 through the notch 43 is for effectuating the rotation of the guiding sleeve 22, relative to the mandrel assembly 300, in the first rotation direction, about the rotation axis, in response to the rotation of the peeler assembly 100, relative to the mandrel assembly 300, in the first rotation direction, about the rotation axis, and for effectuating the rotation of the guiding sleeve 22, relative to the mandrel assembly 300, in the second rotation direction, about the rotation axis, in response to the rotation of the peeler assembly 100, relative to the mandrel assembly 300, in the second rotation direction, about the rotation axis.

In some embodiments, for example, in response to rotation of the peeler assembly 100, relative to the mandrel assembly 300, in the first rotation direction, about the rotation axis, the blade assembly 200 is rotated, relative to the mandrel assembly 300, in the first rotation direction, about the rotation axis. In some embodiments, for example, in response to rotation of the blade assembly 200, relative to the mandrel assembly 300, in the first rotation direction, about the rotation axis, the blade assembly 200, for example, the arm 28, which is extending through the notch 43, becomes disposed in abutting engagement with the guiding sleeve 22. While the blade assembly 200, for example, the arm 28, is disposed in abutting engagement with the guiding sleeve 22, in response to further rotation of the peeler assembly 100, relative to the mandrel assembly 300, in the first rotation direction, about the rotation axis, the blade assembly 200 applies a force to the guiding sleeve 22, with effect that the guiding sleeve 22 is rotated, relative to the mandrel assembly 300, in the first rotation direction, about the rotation axis.

In some embodiments, for example, in response to rotation of the peeler assembly 100, relative to the mandrel assembly 300, in the second rotation direction, about the rotation axis, the blade assembly 200 is rotated, relative to the mandrel assembly 300, in the second rotation direction, about the rotation axis. In some embodiments, for example, in response to rotation of the blade assembly 200, relative to the mandrel assembly 300, in the second rotation direction, about the rotation axis, the blade assembly 200, for example, the arm 28, which is extending through the notch 43, becomes disposed in abutting engagement with the guiding sleeve 22. While the blade assembly 200, for example, the arm 28, is disposed in abutting engagement with the guiding sleeve 22, in response to further rotation of the peeler assembly 100, relative to the mandrel assembly 300, in the second rotation direction, about the rotation axis, the blade assembly 200 applies a force to the guiding sleeve 22, with effect that the guiding sleeve 22 is rotated, relative to the mandrel assembly 300, in the second rotation direction, about the rotation axis.

In some embodiments, for example, the mandrel 32 and the shaft 38 are operably coupled, such that relative rotation, between the mandrel 32 and the shaft 38, in the first and second rotation directions, about the rotation axis, is opposed, for example, prevented. In some embodiments, for example, mandrel 32 and the shaft 38 are operably coupled, such that relative longitudinal displacement, between the mandrel 32 and the shaft 38, in the first and second longitudinal directions, along the displacement axis, is opposed, for example, prevented. In some embodiments, for example, the shaft 38 is a threaded shaft 38, and the mandrel 32 and the shaft 38 are operably coupled via threads of the threaded shaft 38 and threads of the mandrel 32.

In some embodiments, for example, the peeler assembly 100 and the mandrel assembly 300 are operably coupled for effectuating the rotatability of the peeler assembly 100, relative to the mandrel assembly 300, in the first and second rotation directions, about the rotation axis. In some embodiments, for example, the shaft 38 is a threaded shaft 38, and the peeler assembly 100 and the mandrel assembly 300 are operably coupled via threads of the threaded shaft 38 and threads of the shaft receiver 72.

In some embodiments, for example, it is relatively difficult to manufacture the housing 24 such that the shaft receiver 72 includes threads. In such embodiments, for example, the peeler assembly 100 further comprises a coupler 26. In some embodiments, for example, the coupler 26 is operably coupled to the housing 24, such that relative rotation, between the coupler 26 and the housing 24, in the first and second rotation directions, about the rotation axis, is opposed, for example, prevented, and such that relative longitudinal displacement, between the coupler 26 and the housing 24, in the first and second longitudinal directions, along the displacement axis, is opposed, for example, prevented. In some embodiments, for example, the operable coupling between the coupler 26 and the housing 24 is effectuated by pressing the coupler 26 into the housing, for example, into the shaft receiver 72. In some embodiments, for example, the coupler 26 and the housing 24 is operably coupled via press fit, interference fit, friction fit, and the like. In some embodiments, for example, an outer surface 76 of the coupler 26 and the shaft receiver 72 are disposed in engagement, for example, frictional engagement, for example, abutting engagement.

In some embodiments, for example, the coupler 26 and the housing 24 is operably coupled via threads of the shaft receiver 72 and threads defined on the outer surface 76 of the coupler 26.

In some embodiments, for example, the shaft 38 is a threaded shaft 38, and the peeler assembly 100 and the mandrel assembly 300 are operably coupled via threads of the threaded shaft 38 and threads of a threaded channel 74 defined by the coupler 26. In some embodiments, for example, the threaded channel 74 extends through the coupler 26.

In some embodiments, for example, the coupler 26 comprises a mechanically grippable end, for example, a hex end 78.

In some embodiments, for example, the guiding sleeve 22 and the mandrel assembly 300 are operably coupled for effectuating the rotatability of the guiding sleeve 22, relative to the mandrel assembly 300, in the first and second rotation directions, about the rotation axis. In some embodiments, for example, the operable coupling of the guiding sleeve 22 and the mandrel assembly 300 is such that relative longitudinal displacement, between the guiding sleeve 22 and the mandrel assembly 300, in the first and second longitudinal directions, along the displacement axis, is opposed, for example, prevented.

In some embodiments, for example, as depicted in FIG. 9 and FIG. 11 to FIG. 14, the mandrel 32 includes a tubular element engager 322 and a boss 34 extending rearwardly from the tubular element engager 322. In some embodiments, for example, the tubular element engager 322 is disposed in the sleeve cavity 50. The boss 34 extends from the tubular element engager 322, through the sleeve end wall 42, and defines a peripheral groove 84. In some embodiments, for example, a spring clip 36 is received by the peripheral groove 84, with effect that the sleeve end wall 42 is disposed between the tubular element engager 322 and the spring clip 36, thereby operably coupling the sleeve 22 to the mandrel assembly 300. In some embodiments, for example, while the sleeve 22 is operably coupled to the mandrel assembly 300, the tubular element engager 322 and a front-facing surface of the sleeve end wall 42 are disposed in opposing relationship. In some embodiments, for example, while the sleeve 22 is operably coupled to the mandrel assembly 300, the tubular element engager 322 and a front-facing surface of the sleeve end wall 42 are disposed in abutting engagement. In some embodiments, for example, while the sleeve 22 is operably coupled to the mandrel assembly 300, the spring clip 36 and a rear-facing surface of the sleeve end wall 42 are disposed in opposing relationship. In some embodiments, for example, while the sleeve 22 is operably coupled to the mandrel assembly 300, the spring clip 36 and a rear-facing surface of the sleeve end wall 42 are disposed in abutting engagement.

In some embodiments, for example, the shaft 38 is a threaded shaft 38, and the mandrel 32 and the shaft 38 are operably coupled via threads of the threaded shaft 38 and threads of the boss 34.

In some embodiments, for example, the peeler assembly 100, the mandrel assembly 300, and the guiding sleeve 22 are operably coupled for effectuating the longitudinal displaceability of the peeler assembly 100, relative to the mandrel assembly 300 and relative to the guiding sleeve 22, in the first and second longitudinal directions, along the displacement axis, in response to the rotation of the peeler assembly 100, relative to the mandrel assembly 300, in the respective first and second rotation directions, about the rotational axis. In some embodiments, for example, the shaft 38 is a threaded shaft 38, and the peeler assembly 100 and the mandrel assembly 300 are operably coupled via threads of the threaded shaft 38 and threads of the shaft receiver 72, or, in embodiments of the peeler assembly 100 that include the coupler 26, the peeler assembly 100 and the mandrel assembly 300 are operably coupled via threads of the threaded shaft 38 and threads of the threaded channel 74.

In some embodiments, for example, in response to rotation of the peeler assembly 100, relative to the mandrel assembly 300, in the first rotation direction, about the rotation axis, the peeler assembly 100 is longitudinally displaced, relative to the mandrel assembly 300, in the first longitudinal direction, along the displacement axis, for example, via co-operation of the threads of the peeler assembly 100 (e.g. of the shaft receiver 72 or of the coupler 26) and the threads of the shaft 38. As relative longitudinal displacement, between the guiding sleeve 22 and the mandrel assembly 300, in the first longitudinal direction, along the displacement axis, is opposed, for example, prevented, due to the operable coupling of the guiding sleeve 22 and the mandrel assembly 300, in response to rotation of the peeler assembly 100, relative to the mandrel assembly 300, in the first rotation direction, about the rotation axis, the peeler assembly 100 is also longitudinally displaced, relative to the guiding sleeve 22, in the first longitudinal direction, along the displacement axis.

In some embodiments, for example, in response to rotation of the peeler assembly 100, relative to the mandrel assembly 300, in the second rotation direction, about the rotation axis, the peeler assembly 100 is longitudinally displaced, relative to the mandrel assembly 300, in the second longitudinal direction, along the displacement axis, for example, via co-operation of the threads of the peeler assembly 100 (e.g. of the shaft receiver 72 or of the coupler 26) and the threads of the shaft 38. As relative longitudinal displacement, between the guiding sleeve 22 and the mandrel assembly 300, in the second longitudinal direction, along the displacement axis, is opposed, for example, prevented, due to the operable coupling of the guiding sleeve 22 and the mandrel assembly 300, in response to rotation of the peeler assembly 100, relative to the mandrel assembly 300, in the second rotation direction, about the rotation axis, the peeler assembly 100 is also longitudinally displaced, relative to the guiding sleeve 22, in the second longitudinal direction, along the displacement axis.

In some embodiments, for example, the sleeve wall 44 defines a slot 46. As depicted in FIG. 1 to FIG. 4, FIG. 9, and FIG. 12 to FIG. 18, the slot 46 extends longitudinally along an axis that is parallel to the central longitudinal axis 22A of the guiding sleeve 22. In some embodiments, for example, the blade assembly 200 extends from the notch 43 into the slot 46. In some embodiments, for example, while the blade assembly 200 is disposed in the element-receiving configuration, the blade 30 is disposed in the slot 46. In some embodiments, for example, while the blade assembly 200 is disposed in the element-peeling configuration, the blade 30 is disposed in the slot 46.

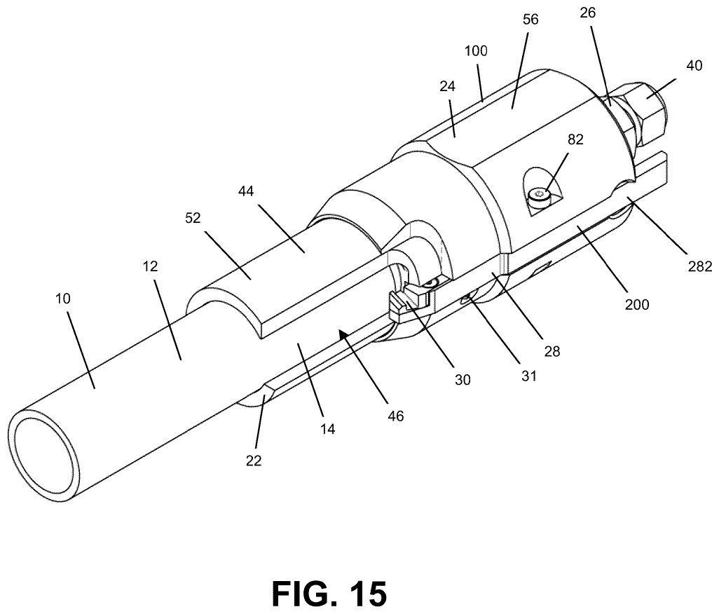

In some embodiments, for example, while the tubular element assembly 10 is received in the sleeve cavity 50, the outer surface 14 of the tubular element 12 of the tubular element assembly 10 that is received in the sleeve cavity 50 is exposed by the slot 46, as depicted in FIG. 15, and the engagement of the blade assembly 200 with the outer surface 14 of the tubular element 12 is engagement of the blade assembly 200 with the outer surface 14 of the tubular element 12 of the tubular element assembly 10 that is received in the sleeve cavity 50 and that is exposed by the slot 46.

To peel the outer surface 14 of a tubular element 12 of the tubular element assembly using the apparatus 20, the guiding sleeve 22 is disposed in the extended configuration, and the blade assembly 200 is disposed in the element-receiving configuration, as depicted in FIG. 12.

To dispose the guiding sleeve 22 in the extended configuration, the peeler assembly 100 is rotated, relative to the mandrel assembly 300, in the second rotation direction that is opposite the first rotation direction, with effect that the guiding sleeve 22 is rotated, relative to the mandrel assembly 300, in the second rotation direction, about the rotation axis; and the peeler assembly 100 is longitudinally displaced, relative to the mandrel assembly 300 and relative to the guiding sleeve 22, in the second longitudinal direction that is opposite the first longitudinal direction, along the displacement axis, such that the minimum spacing distance between the guiding sleeve 22 and the end wall 58 of the housing 24 is increased. In some embodiments, for example, the peeler assembly 100 is rotated, relative to the mandrel assembly 300, in the second rotation direction, to effectuate disposition of the guiding sleeve 22 in the fully extended configuration.

To dispose the blade assembly 200 in the element-receiving configuration, a force is applied to the arm 28, for example, by an operator of the apparatus 200, that overcomes the biasing force applied by the biasing element 29 to the arm 28, with effect that the blade assembly 200 is rotated, relative to the housing 24, about the fastener 82, and becomes disposed in the element-receiving configuration, as depicted in FIG. 12.

While: (i) the guiding sleeve 22 is disposed in the extended configuration, and (ii) the blade assembly 200 is disposed in the element-receiving configuration: the tubular element assembly 10 is receivable in the sleeve cavity 50 of the guiding sleeve 22 for disposing the tubular element assembly 10 in engagement with the mandrel 32. At this point, the tubular assembly 10 is receivable in the sleeve cavity 50 of the guiding sleeve 22. The receiving of the tubular element assembly 10 in the sleeve cavity 50 of the guiding sleeve 22 is with effect that the apparatus 20 and the tubular element assembly 10 become disposed in alignment via co-operation of the inward-facing guide surface 48 of the sleeve wall 44 and the outer surface 14 of the tubular element 12. In some embodiments, for example, in response to inserting of the tubular element assembly 10 in the sleeve cavity 50 of the guiding sleeve 22, the tubular element assembly 10, for example, the outer surface 14 of the tubular element 12, becomes disposed in contact engagement with the inward-facing guide surface 48 of the sleeve wall 44. In response to further inserting of the tubular element assembly 10 in the sleeve cavity 50, a force is applied to the inward-facing guide surface 48 of the sleeve wall 44 by the tubular element assembly 10, for example, the outer surface 14 of the tubular element 12, and the inward-facing guide surface 48 of the sleeve wall 44 applies an alignment reaction force to the tubular element assembly 10, for example, the outer surface 14 of the tubular element 12, with effect that the apparatus 20 and the tubular element assembly are disposed in alignment. In some embodiments, for example, while the apparatus 20 and the tubular element assembly 10 are disposed in alignment, the apparatus 20 and the tubular element assembly 10 are disposed in alignment about an alignment axis that is parallel to the central longitudinal axis of the guiding sleeve 22 or of the housing 24.

While the apparatus 20 and the tubular element assembly 10 are disposed in alignment, the tubular element assembly 10 is further inserted into the guiding sleeve 22, with effect that the tubular element assembly 10 is disposed in engagement with the mandrel 32, for example, with the element engager 322 of the mandrel 32. In some embodiments, for example, while the tubular element assembly 10 and the mandrel 32 are disposed in engagement, friction is established between the tubular element assembly 10 and the mandrel 32. In some embodiments, for example, an outer surface 83 of the element engager 322 is knurled, for increasing the friction established between the tubular element assembly 10 and the mandrel 32 while the tubular element assembly 10 and the mandrel 32 are disposed in engagement. In some embodiments, for example, the engagement of the tubular element assembly 10 and the mandrel 32 is a frictional engagement.

In some embodiments, for example, at this point, the outer surface 14 of the tubular element 12 is disposed adjacent the blade 30, but not in engagement with the blade 30.

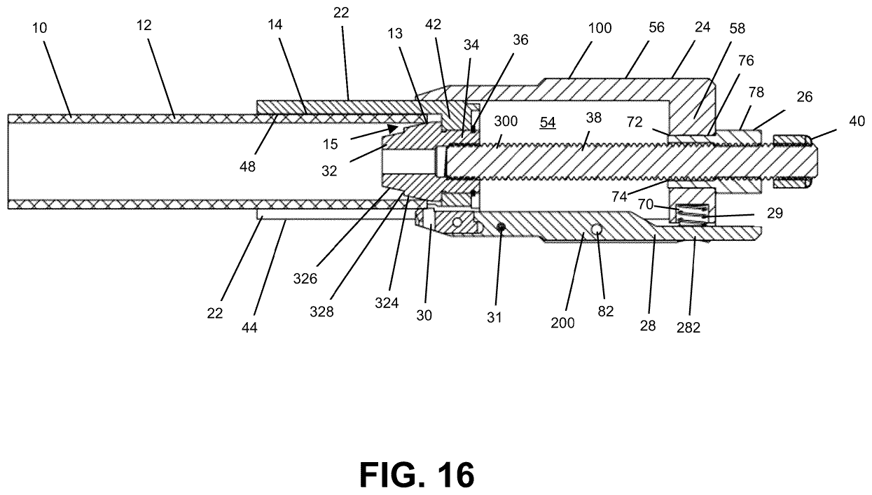

While: (i) the guiding sleeve 22 is disposed in the extended configuration, (ii) the tubular element assembly 10 is received in the sleeve cavity 50 of the guiding sleeve 22, such that the apparatus 20 and the tubular element assembly 10 are disposed in alignment, (iii) the tubular element assembly 10 is disposed in engagement with the mandrel 32, and (iv) the blade assembly 200 is disposed in the element-receiving configuration: the blade assembly 200 is transitioned from the element-receiving configuration to the element-peeling configuration, as depicted in FIG. 13, with effect that the blade assembly 200, for example, the blade 30, becomes disposed in engagement with the outer surface 14 of the tubular element 12, for example, with the outer surface 14 of the tubular element 12 of the tubular element assembly 10 that is received in the sleeve cavity 50 and that is exposed by the slot 46, as depicted in FIG. 15 and FIG. 16.

In some embodiments, for example, to transition the blade assembly 200 from the element-receiving configuration to the element-peeling configuration, the force that is being applied to the arm 28 for overcoming the biasing force applied to the arm 28 by the biasing element 29, is defeated, such that the blade assembly 200 is rotated, relative to the housing 24, about the fastener 82, by the biasing force applied to the arm 28 by the biasing element 29, and becomes disposed in the element-peeling configuration, with effect that the blade assembly 200, for example, the blade 30, becomes disposed in engagement with the outer surface 14 of the tubular element 12.

In some embodiments, for example, at this point, in response to the transition of the blade assembly 200 from the element-receiving configuration to the element-peeling configuration, the blade assembly 200, for example, the blade 30, becomes disposed in engagement with a leading edge of the outer surface 14 of the tubular element 12 of the tubular element assembly 10 that is received in the sleeve cavity 50 and that is exposed by the slot 46.

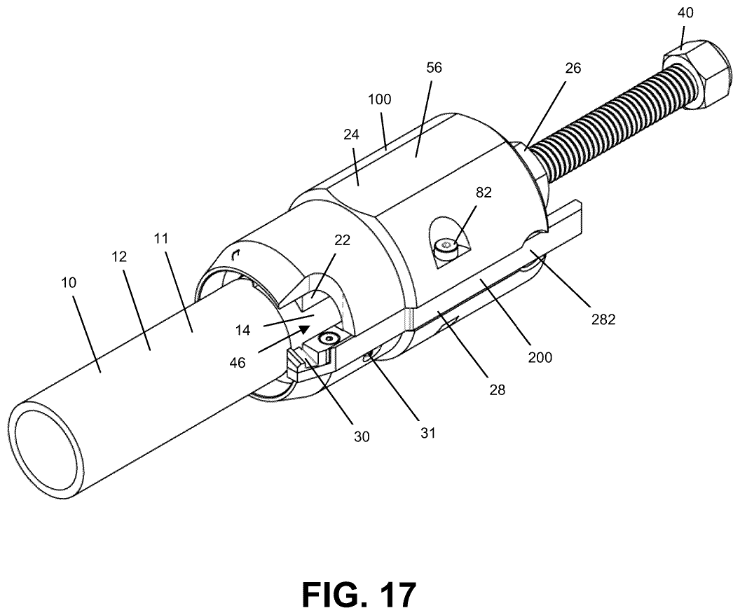

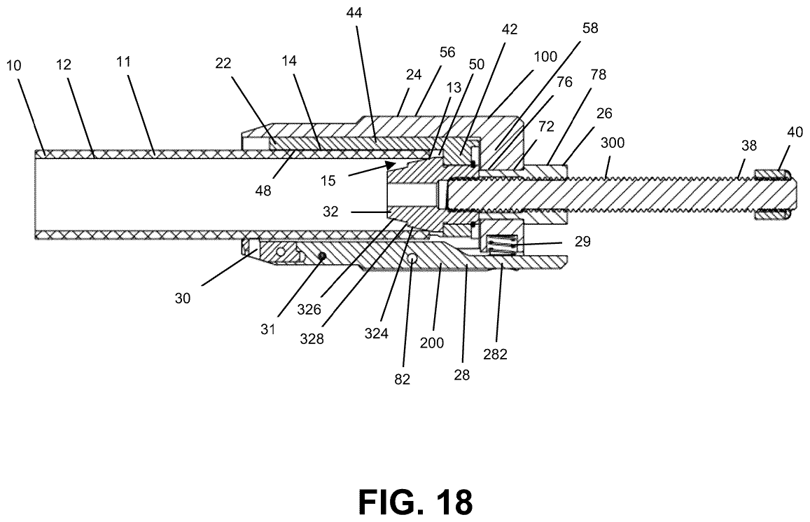

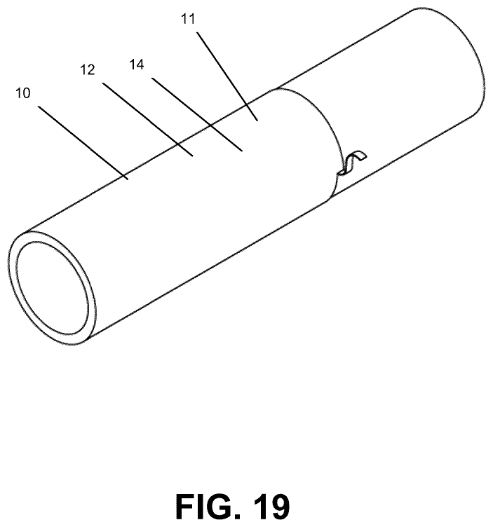

While: (i) the guiding sleeve 22 is disposed in the extended configuration, (ii) the tubular element assembly 10 is received in the sleeve cavity 50 of the guiding sleeve 22, such that the apparatus 20 and the tubular element assembly 10 are disposed in alignment, (iii) the tubular element assembly 10 is disposed in engagement with the mandrel 32, for example, the element engager 322, and (iv) the blade assembly 200 is disposed in the element-peeling configuration, such that the blade assembly 200, for example, the blade 30, is disposed in engagement with the outer surface 14 of the tubular element 12: the peeler assembly 100 is rotated, relative to the mandrel assembly 300 and relative to the tubular element assembly 10. In response to rotation of the peeler assembly 100, relative to the mandrel assembly 300 and relative to the tubular element assembly 10, in the first rotation direction, about the rotation axis: the guiding sleeve 22 is rotated, relative to the mandrel assembly 300 and relative to the tubular element assembly 10, in the first rotation direction, about the rotation axis, and the peeler assembly 100 is longitudinally displaced, relative to the mandrel assembly 300, the guiding sleeve 22, and the tubular element assembly 10, in the first longitudinal direction, along the displacement axis, with effect that the outer surface 14 of the tubular element 12 is peeled by the blade assembly 200, for example, the blade 30, such that a peeled tubular element assembly 11 is defined, and with further effect that the guiding sleeve 22 becomes disposed in the retracted configuration, as depicted in FIG. 17 and FIG. 18. FIG. 19 depicts an example embodiment of the peeled tubular element assembly 11.

In some embodiments, for example, while: (i) the tubular element assembly 10 is received in the sleeve cavity 50 of the guiding sleeve 22, such that the apparatus 20 and the tubular element assembly 10 are disposed in alignment via co-operation of the inward-facing guide surface 48 of the sleeve wall 44 and the outer surface 14 of the tubular element 12, (ii) the tubular element assembly 10 is disposed in engagement with the mandrel 32, and (iii) the blade assembly 200, for example, the blade 30, is disposed in engagement with the outer surface 14 of the tubular element 12: in response to rotation of the peeler assembly 100, relative to the mandrel assembly 300 and relative to the tubular element assembly 10, in the first rotation direction, about the rotation axis: the guiding sleeve 22 is rotated, relative to the mandrel assembly 300 and relative to the tubular element assembly 10, in the first rotation direction, about the rotation axis, and the peeler assembly 100 is longitudinally displaced, relative to the mandrel assembly 300, the guiding sleeve 22, and the tubular element assembly 10, in the first longitudinal direction, along the displacement axis, with effect that the outer surface 14 of the tubular element 12 is peeled by the blade assembly 200, for example, the blade 30, such that the peeled tubular element assembly 11 is defined, as depicted in FIG. 17 and FIG. 18. The blade 30 is urged by the biasing force applied to the arm 28 by the biasing element 29 to maintain disposed in engagement with the outer surface 14 of the tubular element 12 while the peeler assembly 100 is being rotated, relative to the mandrel assembly 300 and relative to the tubular element assembly 10, in the first rotation direction, about the rotation axis.

At this point, in some embodiments, for example, the peeler assembly 100 is further rotated, relative to the mandrel assembly 300 and relative to the tubular element assembly 10, in the first rotation direction, about the rotation axis, to further peel the outer surface 14 of the tubular element 12, until the desired amount of peeling of the outer surface 14 of the tubular element 12 is effectuated. While the desired amount of peeling of the outer surface 14 of the tubular element 12 is effectuated, the rotating of the peeler assembly 100, relative to the mandrel assembly 300 and relative to the tubular element assembly 10, in the first rotation direction, about the rotation axis, is stopped, and the peeling is completed.

In some embodiments, for example, while: (i) the guiding sleeve 22 is disposed in the extended configuration, (ii) the tubular element assembly 10 is received in the sleeve cavity 50 of the guiding sleeve 22, such that the apparatus 20 and the tubular element assembly 10 are disposed in alignment, (iii) the tubular element assembly 10 is disposed in engagement with the mandrel 32, and (iv) the blade assembly 200 is disposed in the element-peeling configuration, such that the blade assembly 200, for example, the blade 30, is disposed in engagement with the outer surface 14 of the tubular element 12: in response to a force applied to the peeler assembly 100 to urge rotation of the peeler assembly 100, in the first rotation direction, about the rotation axis, a force is applied to the mandrel assembly 300, for example, the shaft 38, via the operable coupling between the peeler assembly 100 and the mandrel assembly 300, for example, via the threads of the threaded shaft 38 and the and threads of the shaft receiver 72, or, in embodiments of the peeler assembly 100 that include the coupler 26, via the threads of the threaded shaft 38 and the threads of the threaded channel 74, which urges the mandrel assembly 300 to rotate, in the first rotation direction, about the rotation axis. Such force applied to the mandrel assembly 300 is opposed by the friction established between the tubular element assembly 10 and the mandrel 32, for example, the element engager 322, and, in some embodiments, for example, does not overcome the friction established between the tubular element assembly 10 and the mandrel 32, for example, the element engager 322, such that, in response to the force applied to the peeler assembly 100 to urge rotation of the peeler assembly 100, in the first rotation direction, about the rotation axis, rotation of the mandrel assembly 300, in the first rotation direction, about the rotation axis, is opposed, for example, prevented, by the friction established between the tubular element assembly 10 and the mandrel 32, for example, the element engager 322, with effect that the peeler assembly 100 is rotated, relative to the mandrel assembly 300, in the first rotation direction, about the rotation axis.

In some embodiments, for example, while: (i) the guiding sleeve 22 is disposed in the extended configuration, (ii) the tubular element assembly 10 is received in the sleeve cavity 50 of the guiding sleeve 22, such that the apparatus 20 and the tubular element assembly 10 are disposed in alignment, (iii) the tubular element assembly 10 is disposed in engagement with the mandrel 32, for example, the element engager 322, and (iv) the blade assembly 200 is disposed in the element-peeling configuration, such that the blade assembly 200, for example, the blade 30, is disposed in engagement with the outer surface 14 of the tubular element 12: in response to rotation of the peeler assembly 100, relative to the mandrel assembly 300 and relative to the tubular element assembly 10, in the first rotation direction, about the rotation axis: the blade assembly 200, for example, the blade 30, is rotationally and longitudinally displaced, relative to the outer surface 14 of the tubular element 12, for peeling the outer surface 14 of the tubular element 12. In some embodiments, for example, the blade assembly 200, for example, the blade 30, is displaced, relative to the outer surface 14 of the tubular element 12, in a helical or spiral path, for peeling the outer surface 14 of the tubular element 12.

In some embodiments, for example, while: (i) the guiding sleeve 22 is disposed in the extended configuration, (ii) the tubular element assembly 10 is received in the sleeve cavity 50 of the guiding sleeve 22, such that the apparatus 20 and the tubular element assembly 10 are disposed in alignment, (iii) the tubular element assembly 10 is disposed in engagement with the mandrel 32, for example, the element engager 322, and (iv) the blade assembly 200 is disposed in the element-peeling configuration, such that the blade assembly 200, for example, the blade 30, is disposed in engagement with the outer surface 14 of the tubular element 12: in response to rotation of the peeler assembly 100, relative to the mandrel assembly 300 and relative to the tubular element assembly 10, in the first rotation direction, about the rotation axis: the guiding sleeve 22, the mandrel 32, for example, the tubular element engager 322, and the tubular element assembly 10 are further received in the housing 24 while the outer surface 14 of the tubular element 12 is being peeled by the blade assembly 200, for example, the blade 30.

In some embodiments, for example, to peel the outer surface 14 of the tubular element 12 of the tubular element assembly 10, the peeler assembly 100 is rotated, relative to the mandrel assembly 300 and relative to the tubular element assembly 10, in the first rotation direction, about the rotation axis, until the guiding sleeve 22 becomes disposed in the fully retracted configuration, as depicted in FIG. 18. At this point, the rotation of the peeler assembly 100, relative to the mandrel assembly 300 and relative to the tubular element assembly 10, in the first rotation direction, about the rotation axis, is stopped, and the peeling is completed.

In some embodiments, for example, the peeler assembly 100 can be rotated manually. In some embodiments, for example, the outer surface 56 of the housing 24 is knurled to improve gripping of the housing 24 by an operator for manual rotation of the peeler assembly 100. In some embodiments, for example, wherein the peeler assembly 100 includes the coupler 26, the peeler assembly 100 can be rotated with a hand crank or hex-drive adapter attached to a cordless drill or similar via the hex end 78 of the coupler 26.

In some embodiments, for example, while: (i) the guiding sleeve 22 is disposed in the retracted configuration, (ii) the peeled tubular element assembly 11 is defined, received in the sleeve cavity 50 of the guiding sleeve 22, and disposed in engagement with the mandrel 32, and (iii) the blade assembly 200 is disposed in the element-peeling configuration, such that the blade assembly 200, for example, the blade 30, is disposed in engagement with the outer surface 14 of the tubular element 12: the blade assembly 200 is transitionable from the element-peeling configuration to the element-receiving configuration, for example, by applying a force to the arm 28 that overcomes the biasing force applied to the arm 28 by the biasing element 29, for disengagement of the peeled tubular element assembly 11 from the mandrel 32.

In some embodiments, for example, while: (i) the peeled tubular element assembly 11 is defined, received in the sleeve cavity 50 of the guiding sleeve 22, and disposed in engagement with the mandrel 32, and (ii) the blade assembly 200, for example, the blade 30, is disposed in engagement with the outer surface 14 of the tubular element 12: the contact engagement of the blade assembly 200, for example, the blade 30, with the outer surface 14 of the tubular element 12 is defeatable, for example, by transitioning the blade assembly 200 from the element-peeling configuration to the element-receiving configuration, for disengagement of the peeled tubular element assembly 11 from the mandrel 32.

In some embodiments, for example, while: (i) the guiding sleeve 22 is disposed in the retracted configuration, (ii) the peeled tubular element assembly 11 is defined, received in the sleeve cavity 50 of the guiding sleeve 22, and disposed in engagement with the mandrel 32, and (iii) the blade assembly 200 is disposed in the element-receiving configuration, such that there is an absence of engagement of the blade assembly 200, for example, the blade 30, with the outer surface 14 of the tubular element 12: the apparatus 20 is displaced, relative to the peeled tubular element assembly 11, for example, in a direction away from the peeled tubular element assembly 11, with effect that the engagement between the peeled tubular element assembly 11 and the mandrel 32, for example, the element engager 322, is defeated, and with further effect that the peeled tubular element assembly 11 becomes disposed out of the sleeve cavity 50. At this point, the peeled tubular element assembly 11 can be coupled with another component, and the guiding sleeve 22 is transitionable to the extended configuration, as depicted in FIG. 12, for example, to the fully extended configuration, for peeling an outer surface 14 of a tubular element 12 of another tubular element assembly 10.

In some embodiments, for example, it is desirable to transition the blade assembly 200 from the element-receiving configuration to the element-peeling configuration, prior to defeating the engagement of the peeled tubular element assembly 11 from the mandrel 32 and prior to displacing the apparatus 20, relative to the peeled tubular element assembly 11, for example, in a direction away from the peeled tubular element assembly 11, to avoid gouging of the outer surface 14 of the tubular element 12 of the peeled tubular element assembly 11.

In some embodiments, for example, as depicted in FIG. 16 and FIG. 18, the tubular element 12 includes an inner edge 13, radially spaced inwardly apart, relative to a central longitudinal axis of the tubular element 12, from the outer surface 14 of the tubular element 12. In some embodiments, for example, the inner edge 13 defines an opening 15 of the tubular element 12. In some embodiments, for example, the outer surface 83 of the mandrel 32, for example, the outer surface 83 of the element engager 322, comprises a tapered outer surface 324 that is configured to engage with the inner edge 13 of the tubular element 12. In some embodiments, for example, the tapered outer surface 324 is a frustoconical outer surface. In some embodiments, for example, the engagement of the mandrel 32 to the tubular element assembly 10 is effectuated by engagement of the tapered outer surface 324 of the tubular element engager 322 of the mandrel 32 to the inner edge 13 of the tubular element 12. In some embodiments, for example, the tapered outer surface 324 is knurled, for increasing the friction established between the inner edge 13 of the tubular element 12 and the tapered outer surface 324 while the inner edge 13 of the tubular element 12 and the tapered outer surface 324 are disposed in engagement.

In some embodiments, for example, wherein the tapered outer surface 324 is a frustoconical outer surface, the tapered outer surface 324 is a minimum diameter having a minimum value of at least seven (7) millimeters. In some embodiments, for example, wherein the tapered outer surface 324 is a frustoconical outer surface, the tapered outer surface 324 is a minimum diameter having a value of 7.3 millimeters.

In some embodiments, for example, the tapered outer surface 324 is tapered by an angle having a minimum value of at least 10 degrees, for example, at least 12 degrees, relative to a central longitudinal axis of the mandrel 32. In some embodiments, for example, the tapered outer surface 324 is tapered by 12 degrees, relative to a central longitudinal axis of the mandrel 32.

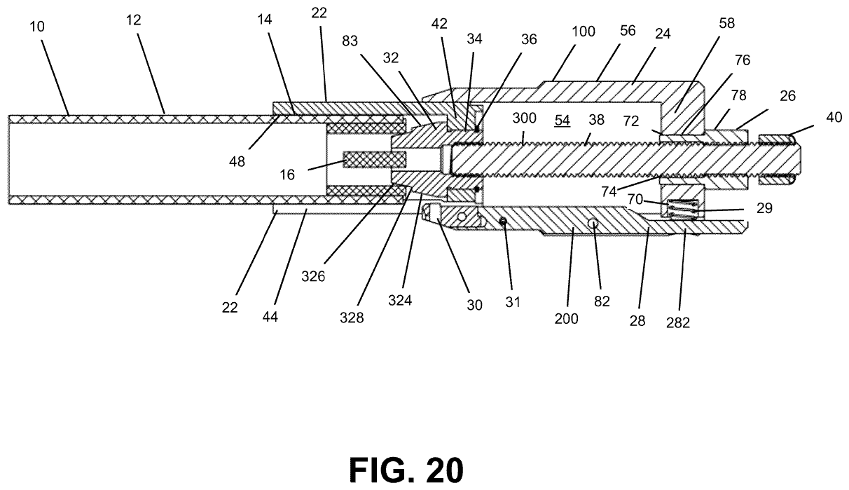

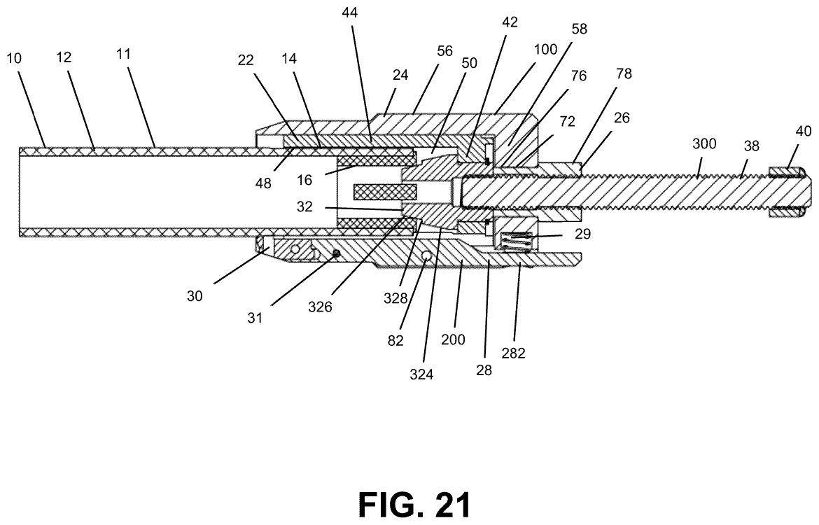

In some embodiments, for example, as depicted in FIG. 20 and FIG. 21, the tubular element assembly 10 further comprises a flow control valve 16 that is operably coupled to the tubular element 12. In some embodiments, for example, the flow control valve 16 is an excess flow valve, which his configured to oppose, for example, prevent, the flow of fluid in the tubular element 12 through the flow control valve 16 in response to an increase in flow of fluid such that the flow of fluid exceeding a predetermined limit. In some embodiments, for example, the engagement of the mandrel 32 to the tubular element assembly 10 is effectuated by engagement of the tapered outer surface 324 of the tubular element engager 322 of the mandrel 32 to the flow control valve 16. In some embodiments, for example, the tapered outer surface 324 is a first tapered outer surface 324, the mandrel 32 further comprises a second tapered outer surface 326. In some embodiments, for example, the second tapered outer surface 326 configured to engage with the flow control valve 16. In some embodiments, for example, the second tapered outer surface 326 is a frustoconical outer surface. In some embodiments, for example, the second tapered outer surface 326 is disposed forwardly of the first tapered outer surface 324. In some embodiments, for example, the maximum diameter of the second tapered outer surface 326 is less than the minimum diameter of the first tapered outer surface 324. In some embodiments, for example, a radial step 328 is defined between the first tapered outer surface 324 and the second tapered outer surface 326. In some embodiments, for example, the engagement of the mandrel 32 to the tubular element assembly 10 is effectuated by engagement of the second tapered outer surface 326 of the tubular element engager 322 of the mandrel 32 to the flow control valve 16 of the tubular element assembly 10. In some embodiments, for example, the second tapered outer surface 326 is knurled, for increasing the friction established between the flow control valve 16 and the second tapered outer surface 326 while the flow control valve 16 and the second tapered outer surface 326 are disposed in engagement.

In some embodiments, for example, the first tapered outer surface 324 is tapered by an angle having a minimum value of at least 10 degrees, for example, at least 12 degrees, relative to a central longitudinal axis of the mandrel 32. In some embodiments, for example, the first tapered outer surface 324 is tapered by 12 degrees, relative to a central longitudinal axis of the mandrel 32. In some embodiments, for example, the second tapered outer surface 326 is tapered by an angle having a minimum value of at least 10 degrees, for example, at least 12 degrees, relative to a central longitudinal axis of the mandrel 32. In some embodiments, for example, the second tapered outer surface 326 is tapered by 12 degrees, relative to a central longitudinal axis of the mandrel 32.

In some embodiments, for example, wherein the second tapered outer surface 326 is a frustoconical outer surface, the second tapered outer surface 326 is a minimum diameter having a minimum value of at least seven (7) millimeters. In some embodiments, for example, wherein the second tapered outer surface 326 is a frustoconical outer surface, the second tapered outer surface 326 is a minimum diameter having a value of 7.3 millimeters.

In some embodiments, for example, wherein the first tapered outer surface 324 is a frustoconical outer surface and the second tapered outer surface 326 is a frustoconical outer surface, the minimum outer diameter of the first tapered outer surface 324 is greater than the maximum outer diameter of the second tapered outer surface 326 by at least five (5) millimeters.

In some embodiments, for example, a method of peeling an outer surface 14 of a tubular element 12 of a tubular element assembly 10 with the apparatus 20 comprises: while: (i) the tubular element assembly 10 is received in the sleeve cavity 50 of the guiding sleeve 22, such that the apparatus 20 and the tubular element assembly 10 are disposed in alignment via co-operation of the inward-facing guide surface 48 of the sleeve wall 44 and the outer surface 14 of the tubular element 12, (ii) the tubular element assembly 10 is disposed in engagement with the mandrel 32, and (iii) the blade assembly 200, for example, the blade 30, is disposed in engagement with the outer surface 14 of the tubular element 12:
rotating the peeler assembly 100, relative to the mandrel assembly 300 and relative to the tubular element assembly 10, in the first rotation direction, about the rotation axis, with effect that the guiding sleeve 22 is rotated, relative to the mandrel assembly 300 and relative to the tubular element assembly 10, in the first rotation direction, and the peeler assembly 100 is longitudinally displaced, relative to the mandrel assembly 300, the guiding sleeve 22, and the tubular element assembly 10, in the first longitudinal direction, along the displacement axis, with effect that the outer surface 14 of the tubular element 12 is peeled by the blade assembly 200, for example, the blade 30, such that the peeled tubular element assembly 11 is defined.

In some embodiments, for example, the apparatus 20 includes the guiding sleeve 22 that includes the inward-facing guide surface 48 that is configured to co-operate with the outer surface 14 of the tubular element 12 of the tubular element assembly 10 to effectuate alignment between the apparatus 20 and the tubular element assembly 10. In some embodiments, for example, the aligning of the apparatus 20 and the tubular element assembly 10 is for improving engagement of the blade assembly 200, for example, the blade 30, with the outer surface 14 of the tubular element 12, which is urged by the biasing element 29, for improving the quality of the peeling of the outer surface 14 of the tubular element 12. In some embodiments, for example, the alignment of the apparatus 20 and the tubular element assembly 10 is such that the guiding sleeve 22, housing 24, mandrel 32, and shaft 38, and the tubular element 12 are aligned along an alignment axis that is parallel to the central longitudinal axis 22A of the guiding sleeve 22 or the central longitudinal axis 24A of the housing 24 (or to the central longitudinal axis of the mandrel 32, or to the central longitudinal axis of the shaft 38).

In some embodiments, for example, the taped outer surface 324 of the element engager 322 is configured such that the element engager 322 is engageable with tubular elements 12 with inner edge 13 of variable diameter (e.g. tubular elements 12 with variable thickness). In some embodiments, for example, the taped outer surface 326 of the element engager 322 is configured such that the element engager 322 is engageable with flow control valves 16 with openings of variable diameter (e.g. different embodiments of flow control valves 16).

In some embodiments, for example, while the mandrel 32 is engaged with the tubular element assembly 10, there is relatively limited protrusion of the mandrel 32 into the tubular element 12 or the flow control valve 16, such that relatively limited space, in the longitudinal direction, is required for engaging the mandrel 32 with the tubular element assembly 10.

In some embodiments, for example, the blade assembly 200 is disposed in the longitudinally extending slot 60 of the housing 24 and the longitudinally extending slot 46 of the guiding sleeve 22, as depicted in FIG. 1 and FIG. 9. In some embodiments, for example, the blade assembly 200 is disposed longitudinally lengthwise of the housing 24 and of the housing 22. In some embodiments, for example, such disposition of the blade assembly 200 is for reducing the size of the apparatus 20, such that the apparatus 20 is usable in environments where space is constrained, such as for peeling an outlet pipe of a tap tee.

In some embodiments, for example, the blade assembly 200 can be decoupled from the housing 24 by removing the fastener 82, such that the blade assembly 200, for example, the blade 30, can be replaced after the blade 30 is worn or damaged.

In some embodiments, for example, the mandrel 32 is configured to engage a tubular element assembly 10 having a tubular element 12 with at least 0.5 inches iron pipe size (IPS), for example, at least 0.75 inches IPS, for example, at least one inch IPS, for example, at least 1.25 inches IPS, for example, at least 1.5 inches IPS, for example, at least 2″ IPS. In some embodiments, for example, the mandrel 32 is configured to engage a tubular element assembly 10 having a tubular element 12 with at least 0.5 inches copper tube size (CTS), for example, at least 0.75 inches CTS, for example, at least one inch CTS, for example, at least 1.25 inches CTS, for example, at least 1.5 inches CTS, for example, at least 2″ CTS.

In some embodiments, for example, a material of manufacture of the tubular element 12 includes plastic. In some embodiments, for example, a material of manufacture of the tubular element 12 includes polyethylene. In some embodiments, for example, a material of manufacture of the tubular element 12 includes high-density polyethylene.

In some embodiments, for example, a material of manufacture of the blade 30 includes metal. In some embodiments, for example, a material of manufacture of the blade 30 includes hardened high carbon tool steel. In some embodiments, for example, a material of manufacture of the blade 30 includes tungsten carbide.

In some embodiments, for example, a material of manufacture of the guiding sleeve 22 includes metal, for example, aluminum.

In some embodiments, for example, a material of manufacture of the housing 24 includes metal, for example, aluminum.

In some embodiments, for example, a material of manufacture of the mandrel 32 includes metal, for example, aluminum.

In some embodiments, for example, a material of manufacture of the shaft 38 includes metal, for example, steel.

In some embodiments, for example, a material of manufacture of the coupler 26 includes metal, for example, brass, for example, steel.

In some embodiments, for example, a material of manufacture of the arm 28 includes metal, for example, brass.

In some embodiments, for example, the central longitudinal axis 22A of the guiding sleeve 22, the central longitudinal axis 24A of the housing 24, the central longitudinal axis of the mandrel 32, and the central longitudinal axis of the shaft 38, are disposed in a parallel relationship.

In some embodiments, for example, the coupler 26 and the housing 24 are integrally formed, such that the coupler 26 and the housing 24 define a unitary one-piece body. In some embodiments, for example, the operable coupling of the coupler 26 and the housing 24 is effectuated otherwise than by threads.

In some embodiments, for example, the operable coupling of the shaft 38 and the cap nut 40 is effectuated otherwise than by threads.

In some embodiments, for example, the guiding sleeve 22 is operably coupled to the shaft 38 otherwise than via the spring clip 36.

In some embodiments, for example, the longitudinal length of the portion of the tubular element 12 that is peeled, in response to rotation of the peeler assembly 100 in the first rotation direction, such that the guiding sleeve 22 is transitioned from the fully extended configuration to the fully retracted position, has a minimum value of at least 46 millimeters.

The preceding discussion provides many example embodiments. Although each embodiment represents a single combination of inventive elements, other examples may include all suitable combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations could be made herein.

Moreover, the scope of the present application is not intended to be limited to the particular embodiments of the process, machine, manufacture, and composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be examples only. The invention is defined by the appended claims.

What is claimed is:

1. An apparatus for peeling an outer surface of a tubular element of a tubular element assembly, the apparatus comprising:
a peeler assembly, comprising:
a housing, comprising an end wall; and
a blade assembly, comprising a blade, the blade assembly operably coupled to the housing, and configurable in an element-receiving configuration and an element-peeling configuration;
a guiding sleeve, disposed in the housing, the guiding sleeve comprising:
a sleeve end wall; and
a sleeve wall that extends from the sleeve end wall, the sleeve wall defining a sleeve cavity configured to receive the tubular element assembly, the sleeve wall including an inward-facing guide surface that is configured to co-operate with the outer surface of the tubular element to align the apparatus and the tubular element assembly, in response to receiving of the tubular element assembly in the sleeve cavity of the guiding sleeve;
wherein the guiding sleeve is configurable in a retracted configuration and an extended configuration;
a mandrel assembly, extending through the sleeve end wall, the mandrel assembly comprising:
a mandrel, configured to engage with the tubular element assembly; and
a shaft, received in the end wall of the housing;
wherein:
in the element-receiving configuration of the blade assembly, there is an absence of disposition of the blade in the sleeve cavity, and, in the element-peeling configuration of the blade assembly, the blade is disposed closer to a central longitudinal axis of the guiding sleeve, relative to its disposition while in the element-receiving configuration;
in the extended configuration of the guiding sleeve, the guiding sleeve is spaced further apart from the end wall of the housing, relative to its disposition while in the retracted configuration;
the peeler assembly, the guiding sleeve, and the mandrel assembly are co-operatively configured such that:
in response to rotation of the peeler assembly, relative to the mandrel assembly, in a first rotation direction, about a rotation axis that is parallel to a central longitudinal axis of the housing:
the guiding sleeve is rotated, relative to the mandrel assembly, in the first rotation direction, about the rotation axis; and
the peeler assembly is longitudinally displaced, relative to the mandrel assembly and relative to the guiding sleeve, in a first longitudinal direction, along a displacement axis that is parallel to the central longitudinal axis of the housing, such that a minimum spacing distance between the guiding sleeve and the end wall of the housing is decreased; and
in response to rotation of the peeler assembly, relative to the mandrel assembly, in a second rotation direction that is opposite the first rotation direction, about the rotation axis:
the guiding sleeve is rotated, relative to the mandrel assembly, in the second rotation direction, about the rotation axis; and
the peeler assembly is longitudinally displaced, relative to the mandrel assembly and relative to the guiding sleeve, in a second longitudinal direction that is opposite the first longitudinal direction, along the displacement axis, such that the minimum spacing distance between the guiding sleeve and the end wall of the housing is increased;
while: (i) the guiding sleeve is disposed in the extended configuration, and (ii) the blade assembly is disposed in the element-receiving configuration:
the tubular element assembly is receivable in the sleeve cavity of the guiding sleeve for disposing the tubular element assembly in engagement with the mandrel, the receiving of the tubular element assembly in the sleeve cavity of the guiding sleeve is with effect that the apparatus and the tubular element assembly become disposed in alignment via co-operation of the inward-facing guide surface of the sleeve wall and the outer surface of the tubular element;
while: (i) the guiding sleeve is disposed in the extended configuration, (ii) the tubular element assembly is received in the sleeve cavity of the guiding sleeve, such that the apparatus and the tubular element assembly are disposed in alignment, (iii) the tubular element assembly is disposed in engagement with the mandrel, and (iv) the blade assembly is disposed in the element-receiving configuration:
the blade assembly is transitioned from the element-receiving configuration to the element-peeling configuration, with effect that the blade becomes disposed in engagement with the outer surface of the tubular element;
while: (i) the guiding sleeve is disposed in the extended configuration, (ii) the tubular element assembly is received in the sleeve cavity of the guiding sleeve, such that the apparatus and the tubular element assembly are disposed in alignment, (iii) the tubular element assembly is disposed in engagement with the mandrel, and (iv) the blade assembly is disposed in the element-peeling configuration, such that the blade is disposed in engagement with the outer surface of the tubular element:
in response to rotation of the peeler assembly, relative to the mandrel assembly and relative to the tubular element assembly, in the first rotation direction, about the rotation axis:
the guiding sleeve is rotated, relative to the mandrel assembly and relative to the tubular element assembly, in the first rotation direction, about the rotation axis, and the peeler assembly is longitudinally displaced, relative to the mandrel assembly, the guiding sleeve, and the tubular element assembly, in the first longitudinal direction, along the displacement axis, with effect that the outer surface of the tubular element is peeled by the blade, such that a peeled tubular element assembly is defined, and with further effect that the guiding sleeve becomes disposed in the retracted configuration.

2. The apparatus of claim 1, wherein:
while: (i) the guiding sleeve is disposed in the retracted configuration, (ii) the peeled tubular element assembly is defined, received in the sleeve cavity of the guiding sleeve, and disposed in engagement with the mandrel, and (iii) the blade assembly is disposed in the element-peeling configuration, such that the blade is disposed in engagement with the outer surface of the tubular element:
the blade assembly is transitionable from the element-peeling configuration to the element-receiving configuration, for disengagement of the peeled tubular element assembly from the mandrel.

3. The apparatus of claim 1, wherein:
the sleeve wall defines a slot;
wherein, while the tubular element assembly is received in the sleeve cavity, the outer surface of the tubular element of the tubular element assembly that is received in the sleeve cavity is exposed by the slot, and the engagement of the blade with the outer surface of the tubular element is engagement of the blade with the outer surface of the tubular element of the tubular element assembly that is received in the sleeve cavity and that is exposed by the slot.

4. The apparatus of claim 1, wherein:
the guiding sleeve defines a notch; and
the blade assembly extends through the notch;
wherein the extension of the blade assembly through the notch is for effectuating the rotation of the guiding sleeve, relative to the mandrel assembly, in the first rotation direction, about the rotation axis, in response to the rotation of the peeler assembly, relative to the mandrel assembly, in the first rotation direction, about the rotation axis, and for effectuating the rotation of the guiding sleeve, relative to the mandrel assembly, in the second rotation direction, about the rotation axis, in response to the rotation of the peeler assembly, relative to the mandrel assembly, in the second rotation direction, about the rotation axis.

5. The apparatus of claim 1, wherein the inward-facing guide surface is an arcuate surface.

6. The apparatus of claim 1, wherein the sleeve cavity has a length, measured along an axis that is parallel to the central longitudinal axis of the guiding sleeve, having a minimum value of at least 46 millimeters.

7. The apparatus of claim 1, wherein:
the tubular element includes an inner edge, radially spaced apart from the outer surface of the tubular element, the inner edge defining an opening of the tubular element; and
the mandrel comprises a tapered outer surface, configured to engage with the inner edge of the tubular element;
wherein the engagement of the mandrel to the tubular element assembly is effectuated by engagement of the tapered outer surface of the mandrel to the inner edge of the tubular element.

8. The apparatus of claim 7, wherein:
the tubular element assembly further comprises a flow control valve that is operably coupled to the tubular element; and
the tapered outer surface is a first tapered outer surface, the mandrel further comprises a second tapered outer surface, the second tapered outer surface configured to engage with the flow control valve;
wherein the engagement of the mandrel to the tubular element assembly is effectuated by engagement of the second tapered outer surface of the mandrel to the flow control valve.

9. The apparatus of claim 1, wherein:
the tubular element assembly further comprises a flow control valve that is operably coupled to the tubular element; and
the mandrel comprises a tapered outer surface, configured to engage with the flow control valve;
wherein the engagement of the mandrel to the tubular element assembly is effectuated by engagement of the tapered outer surface of the mandrel to the flow control valve.

10. The apparatus of claim 1, wherein the blade assembly is biased, by a biasing element, to the element-peeling configuration.

11. An apparatus for peeling an outer surface of a tubular element of a tubular element assembly, the apparatus comprising:
a peeler assembly, comprising:
a housing, comprising an end wall; and
a blade assembly, comprising a blade, the blade assembly operably coupled to the housing;
a guiding sleeve, disposed in the housing, the guiding sleeve comprising:
a sleeve end wall; and
a sleeve wall that extends from the sleeve end wall, the sleeve wall defining a sleeve cavity configured to receive the tubular element assembly, the sleeve wall including an inward-facing guide surface that is configured to co-operate with the outer surface of the tubular element to align the apparatus and the tubular element assembly, in response to receiving of the tubular element assembly in the sleeve cavity of the guiding sleeve;
a mandrel assembly, operably coupled to the guiding sleeve and to the housing, the mandrel assembly comprising:
a mandrel, configured to engage with the tubular element assembly; wherein:
the peeler assembly, the guiding sleeve, and the mandrel assembly are co-operatively configured such that:
in response to rotation of the peeler assembly, relative to the mandrel assembly, in a first rotation direction, about a rotation axis that is parallel to a central longitudinal axis of the housing:
the guiding sleeve is rotated, relative to the mandrel assembly, in the first rotation direction, about the rotation axis; and
the peeler assembly is longitudinally displaced, relative to the mandrel assembly and relative to the guiding sleeve, in a first longitudinal direction, along a displacement axis that is parallel to the central longitudinal axis of the housing, such that a minimum spacing distance between the guiding sleeve and the end wall of the housing is decreased; and
in response to rotation of the peeler assembly, relative to the mandrel assembly, in a second rotation direction that is opposite the first rotation direction, about the rotation axis:
the guiding sleeve is rotated, relative to the mandrel assembly, in the second rotation direction, about the rotation axis; and
the peeler assembly is longitudinally displaced, relative to the mandrel assembly and relative to the guiding sleeve, in a second longitudinal direction that is opposite the first longitudinal direction, along the displacement axis, such that the minimum spacing distance between the guiding sleeve and the end wall of the housing is increased;
while: (i) the tubular element assembly is received in the sleeve cavity of the guiding sleeve, such that the apparatus and the tubular element assembly are disposed in alignment via co-operation of the inward-facing guide surface of the sleeve wall and the outer surface of the tubular element, (ii) the tubular element assembly is disposed in engagement with the mandrel, and (iii) the blade is disposed in engagement with the outer surface of the tubular element:
in response to rotation of the peeler assembly, relative to the mandrel assembly and relative to the tubular element assembly, in the first rotation direction, about the rotation axis:
the guiding sleeve is rotated, relative to the mandrel assembly and relative to the tubular element assembly, in the first rotation direction, about the rotation axis, and the peeler assembly is longitudinally displaced, relative to the mandrel assembly, the guiding sleeve, and the tubular element assembly, in the first longitudinal direction, along the displacement axis, with effect that the outer surface of the tubular element is peeled by the blade, such that a peeled tubular element assembly is defined.

12. The apparatus of claim 11, wherein:
while: (i) the peeled tubular element assembly is defined, received in the sleeve cavity of the guiding sleeve, and disposed in engagement with the mandrel, and (ii) the blade is disposed in engagement with the outer surface of the tubular element:
the contact engagement of the blade with the outer surface of the tubular element is defeatable, for disengagement of the peeled tubular element assembly from the mandrel.

13. The apparatus of claim 11, wherein:
the sleeve wall defines a slot;
wherein, while the tubular element assembly is received in the sleeve cavity, the outer surface of the tubular element of the tubular element assembly that is received in the sleeve cavity is exposed by the slot, and the engagement of the blade with the outer surface of the tubular element is engagement of the blade with the outer surface of the tubular element of the tubular element assembly that is received in the sleeve cavity and that is exposed by the slot.

14. The apparatus of claim 11, wherein:
the guiding sleeve defines a notch; and
the blade assembly extends through the notch;
wherein the extension of the blade assembly through the notch is for effectuating the rotation of the guiding sleeve, relative to the mandrel assembly, in the first rotation direction, about the rotation axis, in response to the rotation of the peeler assembly, relative to the mandrel assembly, in the first rotation direction, about the rotation axis, and for effectuating the rotation of the guiding sleeve, relative to the mandrel assembly, in the second rotation direction, about the rotation axis, in response to the rotation of the peeler assembly, relative to the mandrel assembly, in the second rotation direction, about the rotation axis.

15. The apparatus of claim 11, wherein the inward-facing guide surface is an arcuate surface.

16. The apparatus of claim 11, wherein the sleeve cavity has a length, measured along an axis that is parallel to the central longitudinal axis of the guiding sleeve, having a minimum value of at least 46 millimeters.

17. The apparatus of claim 11, wherein:
the tubular element includes an inner edge, radially spaced apart from the outer surface of the tubular element, the inner edge defining an opening of the tubular element; and
the mandrel comprises a tapered outer surface, configured to engage with the inner surface of the tubular element;
wherein the engagement of the mandrel to the tubular element assembly is effectuated by engagement of the tapered outer surface of the mandrel to the inner edge of the tubular element.

18. The apparatus of claim 17, wherein:
the tubular element assembly further comprises a flow control valve that is operably coupled to the tubular element; and
the tapered outer surface is a first tapered outer surface, the mandrel further comprises a second tapered outer surface, the second tapered outer surface configured to engage with the flow control valve;
wherein the engagement of the mandrel to the tubular element assembly is effectuated by engagement of the second tapered outer surface of the mandrel to the flow control valve.

19. The apparatus of claim 11, wherein:
the tubular element assembly further comprises a flow control valve that is operably coupled to the tubular element; and
the mandrel comprises a tapered outer surface, configured to engage with the flow control valve;
wherein the engagement of the mandrel to the tubular element assembly is effectuated by engagement of the tapered outer surface of the mandrel to the flow control valve.

20. A method of peeling an outer surface of a tubular element of a tubular element assembly with an apparatus,
the apparatus comprising:
a peeler assembly, comprising:
a housing, comprising an end wall; and
a blade assembly, comprising a blade, the blade assembly operably coupled to the housing;
a guiding sleeve, disposed in the housing, the guiding sleeve comprising:
a sleeve end wall; and
a sleeve wall that extends from the sleeve end wall, the sleeve wall defining a sleeve cavity configured to receive the tubular element assembly, the sleeve wall including an inward-facing guide surface that is configured to co-operate with the outer surface of the tubular element to align the apparatus and the tubular element assembly, in response to receiving of the tubular element assembly in the sleeve cavity of the guiding sleeve;
a mandrel assembly, operably coupled to the guiding sleeve and to the housing, the mandrel assembly comprising:
a mandrel, configured to engage with the tubular element assembly;
wherein:
the peeler assembly, the guiding sleeve, and the mandrel assembly are co-operatively configured such that:
in response to rotation of the peeler assembly, relative to the mandrel assembly, in a first rotation direction, about a rotation axis that is parallel to a central longitudinal axis of the housing:
the guiding sleeve is rotated, relative to the mandrel assembly, in the first rotation direction, about the rotation axis; and
the peeler assembly is longitudinally displaced, relative to the mandrel assembly and relative to the guiding sleeve, in a first longitudinal direction, along a displacement axis that is parallel to the central longitudinal axis of the housing, such that a minimum spacing distance between the guiding sleeve and the end wall of the housing is decreased; and
in response to rotation of the peeler assembly, relative to the mandrel assembly, in a second rotation direction that is opposite the first rotation direction, about the rotation axis:
the guiding sleeve is rotated, relative to the mandrel assembly, in the second rotation direction, about the rotation axis; and
the peeler assembly is longitudinally displaced, relative to the mandrel assembly and relative to the guiding sleeve, in a second longitudinal direction that is opposite the first longitudinal direction, along the displacement axis, such that the minimum spacing distance between the guiding sleeve and the end wall of the housing is increased;
the method comprising:
while: (i) the tubular element assembly is received in the sleeve cavity of the guiding sleeve, such that the apparatus and the tubular element assembly are disposed in alignment via co-operation of the inward-facing guide surface of the sleeve wall and the outer surface of the tubular element, (ii) the tubular element assembly is disposed in engagement with the mandrel, and (iii) the blade is disposed in engagement with the outer surface of the tubular element:
rotating the peeler assembly, relative to the mandrel assembly and relative to the tubular element assembly, in the first rotation direction, about the rotation axis, with effect that the guiding sleeve is rotated, relative to the mandrel assembly and relative to the tubular element assembly, in the first rotation direction, and the peeler assembly is longitudinally displaced, relative to the mandrel assembly, the guiding sleeve, and the tubular element assembly, in the first longitudinal direction, along the displacement axis, with effect that the outer surface of the tubular element is peeled by the blade, such that a peeled tubular element assembly is defined.
